(19) United States
(12) Patent Application Publication
(10) Pub. No.: US 2024/0219921 A1
(43) Pub. Date: Jul. 4, 2024

(54) ROBOT CLEANER USING UWB COMMUNICATION, AND CONTROL METHOD FOR SAME

(71) Applicant: Samsung Electronics Co., Ltd., Suwon-si (KR)

(72) Inventors: Jaeyoung JUNG, Suwon-si (KR); Heungryong OH, Suwon-si (KR)

(73) Assignee: Samsung Electronics Co., Ltd., Suwon-si (KR)

(21) Appl. No.: 18/606,133

(22) Filed: Mar. 15, 2024

Related U.S. Application Data
(63) Continuation of application No. PCT/KR2022/011295, filed on Aug. 1, 2022.

(30) Foreign Application Priority Data
Sep. 17, 2021 (KR) 10-2021-0125214

(51) Int. Cl. G05D 1/247; A47L 9/00; A47L 9/28; A47L 11/40; G01S 17/931; G05D 1/661; G05D 105/10

(52) U.S. Cl. CPC G05D 1/247; A47L 9/0063; A47L 9/009; A47L 9/2826; A47L 9/2852; A47L 9/2873; A47L 9/2894; A47L 11/4002; A47L 11/4011; A47L 11/4061; A47L 11/4091; G01S 17/931; G05D 1/661; A47L 2201/022; A47L 2201/04; G05D 2105/10

(57) ABSTRACT

Provided is a method of controlling a robot cleaner. The method of controlling the robot cleaner includes initiating a homing operation of moving the robot cleaner to a charger, detecting, by an ultra-wideband (UWB) antenna of the robot cleaner, a plurality of UWB signals output from a plurality of UWB antennas included in the charger, identifying position information of the charger and position information of the robot cleaner based on the detected plurality of UWB signals, and controlling the robot cleaner to move to the charger based on the identified position information of the charger and the identified position information of the robot cleaner.

### CROSS-REFERENCE TO RELATED APPLICATIONS

This application is a continuation of International Application PCT/KR2022/011295, filed Aug. 1, 2022, which is incorporated herein by reference in its entirety, and claims foreign priority to Korean application 10-2021-0125214, filed Sep. 17, 2021, which is incorporated herein by reference in its entirety.

### TECHNICAL FIELD

Embodiments of the present disclosure relate to a robot cleaner using ultra-wideband (UWB) communication, a method of controlling the robot cleaner, and a recording medium having recorded thereon a program for causing a computer to execute the method of controlling the robot cleaner.

### BACKGROUND ART

Robot cleaners have an autonomous driving function, an object recognition function through a camera and the like, a communication function through Wi-Fi, and the like. Thus, a robot cleaner may serve various roles in implementation of a smart home. When the charge of a battery of a robot cleaner performing various roles falls below a predetermined value, the robot cleaner moves to a charger to perform charging of the battery.

The robot cleaner moves around inside a room, starting from a charger, to generate a cleaning map by using various sensors (e.g., a light detection and ranging (LiDAR) sensor), and thus may recognize the position of the charger on the generated map. Based on the map generated in this way, when the charge of the battery of the robot cleaner falls below a predetermined value or when cleaning is completed, the robot cleaner moves to the vicinity of the charger. Such an operation of a robot cleaner moving to a charger is referred to as a homing operation. Then, the robot cleaner in the vicinity of the charger performs a docking operation such that a charging port of the robot cleaner and a charging port of the charger come into contact with each other.

However, in the homing operation, when a user arbitrarily changes the position of the robot cleaner or the position of the charger while the robot cleaner is operating, it is difficult for the robot cleaner to move to the vicinity of the charger based on the generated cleaning map. Thus, the robot cleaner needs to move around in the room to find the charger.

In addition, in the docking operation, when an obstacle is placed around the charger, a signal output from the charger may be interfered with by the obstacle, causing the robot cleaner to fail to dock.

### DISCLOSURE

### Technical Solution

According to an aspect of an embodiment of the present disclosure, a method of controlling a robot cleaner is provided. The method of controlling the robot cleaner includes initiating a homing operation of moving the robot cleaner to a charger. In addition, the method of controlling the robot cleaner further includes detecting, by an ultra-wideband (UWB) antenna of the robot cleaner, a plurality of UWB signals output from a plurality of UWB antennas included in the charger. In addition, the method of controlling the robot cleaner further includes identifying position information of the charger and position information of the robot cleaner based on the detected plurality of UWB signals. In addition, the method of controlling the robot cleaner further includes controlling the robot cleaner to move to the charger based on the identified position information of the charger and the identified position information of the robot cleaner.

According to an aspect of an embodiment of the present disclosure, the charger includes three UWB antennas arranged at a same height, and the identifying of the position information includes identifying coordinates of the charger and coordinates of the robot cleaner in a coordinate system having an origin at any one of the three UWB antennas included in the charger.

According to an aspect of an embodiment of the present disclosure, the controlling of the robot cleaner to move to the charger includes identifying a movement direction of the robot cleaner to move to the charger, by using the identified position information of the charger and the identified position information of the robot cleaner, identifying an object in front of the robot cleaner by using a detection value of a light detection and ranging (LiDAR) sensor of the robot cleaner, and determining a movement path of the robot cleaner based on information about the identified object in front of the robot cleaner.

According to an aspect of an embodiment of the present disclosure, the method further includes obtaining reliability information of the detected plurality of UWB signals, and controlling a movement speed of the robot cleaner based on the obtained reliability information.

According to an aspect of an embodiment of the present disclosure, the controlling of the movement speed includes, based on reliability of the detected plurality of UWB signals indicated by the obtained reliability information being less than a reference value, controlling the movement speed of the robot cleaner to be less than a reference speed, and, based on the reliability of the detected plurality of UWB signals indicated by the obtained reliability information being greater than or equal to the reference value, controlling the movement speed of the robot cleaner to be greater than or equal to the reference speed.

According to an aspect of an embodiment of the present disclosure, the method further includes, based on reliability of the detected plurality of UWB signals indicated by the obtained reliability information being less than a reference value, controlling an interval of detection of the plurality of UWB signals to be less than or equal to a reference interval, and, based on the reliability of the detected plurality of UWB signals indicated by the obtained reliability information being greater than or equal to the reference value, controlling the interval of detection of the plurality of UWB signals to be greater than or equal to the reference interval.

According to an aspect of an embodiment of the present disclosure, the plurality of UWB antennas of the charger are arranged at a same height. In addition, the method further includes obtaining an angle-of-arrival (AoA) azimuth and an AoA elevation angle of the plurality of UWB signals, and obtaining an AoA azimuth figure of merit (FOM) and an AoA elevation angle FOM of the plurality of UWB signals. In addition, the obtaining of the reliability information includes obtaining the reliability information based on at least one of the obtained AoA azimuth FOM or the obtained AoA elevation angle FOM.

According to an aspect of an embodiment of the present disclosure, the plurality of UWB antennas of the charger and the UWB antenna of the robot cleaner are arranged at a same height, and the obtaining of the reliability information further includes obtaining the reliability information based on whether the AoA elevation angle deviates from 90 degrees by greater than an elevation angle reference value.

According to an aspect of an embodiment of the present disclosure, the charger includes two UWB antennas and an IR communication module. In addition, the identifying of the position information includes determining a first candidate position and a second candidate position of the robot cleaner based on a plurality of UWB signals output from the two UWB antennas, and identifying one of the first candidate position and the second candidate position as a position of the robot cleaner, based on an infrared (IR) signal output from an IR signal module.

According to an aspect of an embodiment of the present disclosure, the charger further includes an IR communication module. In addition, the method further includes detecting an IR signal output from the IR communication module, initiating a docking operation of docking the robot cleaner to the charger based on the detected IR signal, and docking the robot cleaner to the charger such that a charging port of the charger and a charging port of the robot cleaner come into contact with each other, based on the detected IR signal.

According to an aspect of an embodiment of the present disclosure, the IR communication module is configured to output a wide IR signal, a right IR signal, a left IR signal, and a center alignment IR signal, the initiating of the docking operation includes initiating the docking operation based on detecting the wide IR signal, and the docking of the robot cleaner includes docking the robot cleaner based on the right IR signal, the left IR signal, and the center alignment IR signal.

According to an aspect of an embodiment of the present disclosure, the plurality of UWB antennas included in the charger include a second UWB antenna arranged on a right side of the charger and a third UWB antenna arranged on a left side of the charger. In addition, the method further includes determining a first expected direction of the robot cleaner based on a second UWB signal output from the second UWB antenna and a third UWB signal output from the third UWB antenna, determining a second expected direction of the robot cleaner based on a combination of the right IR signal and the left IR signal, and based on determining that the first expected direction and the second expected direction coincide, determining a movement direction of the robot cleaner based on the determined first expected direction and the determined second expected direction.

According to an aspect of an embodiment of the present disclosure, the method further includes, based on determining that the determined first expected direction and the determined second expected direction are different from each other, determining reliability of the second UWB signal and reliability of the third UWB signal, In addition, the method further includes, based on the determined reliability of the second UWB signal or the determined reliability of the third UWB signal being less than a reference value, determining the movement direction of the robot cleaner based on the determined second expected direction. In addition, the method further includes, based on the determined reliability of the second UWB signal being greater than or equal to the reference value and the determined reliability of the third UWB signal being greater than or equal to the reference value, determining the movement direction of the robot cleaner based on the determined first expected direction.

In addition, according to an aspect of an embodiment of the present disclosure, a robot cleaner is provided. The robot cleaner includes an ultra-wideband (UWB) communication module including a UWB antenna and configured to detect a UWB signal. In addition, the robot cleaner further includes a moving assembly. In addition, the robot cleaner further includes a memory storing at least one instruction. In addition, the robot cleaner further includes at least one processor. The at least one processor is configured to execute the at least one instruction to initiate a homing operation of moving the robot cleaner to the charger. In addition, the at least one processor executes the at least one instruction to detect, by the UWB antenna, a plurality of UWB signals output from a plurality of UWB antennas included in the charger. In addition, the at least one processor executes the at least one instruction to identify position information of the charger and position information of the robot cleaner based on the detected plurality of UWB signals. In addition, the at least one processor executes the at least one instruction to control the moving assembly such that the robot cleaner moves to the charger, based on the identified position information of the charger and the identified position information of the robot cleaner.

In addition, according to an aspect of an embodiment of the present disclosure, provided is a non-transitory computer-readable recording medium having recorded thereon a program for executing, on a computer, the method of controlling the robot cleaner.

### DESCRIPTION OF DRAWINGS

FIG. 1 is a diagram illustrating a robot cleaner and a charger according to an embodiment of the present disclosure.

FIG. 2 is a block diagram illustrating structures of a robot cleaner and a charger, according to an embodiment of the present disclosure.

FIG. 3 is a diagram illustrating ultra-wideband (UWB) communication modules of a robot cleaner and a charger, according to an embodiment of the present disclosure.

FIG. 4 is a flowchart of a robot cleaner control method according to an embodiment of the present disclosure.

FIG. 5 is a diagram for describing a process of identifying position information of a robot cleaner and position information of a charger, according to an embodiment of the present disclosure.

FIG. 6 is a diagram illustrating an antenna arrangement of a robot cleaner and a charger, according to an embodiment of the present disclosure.

FIG. 7 is a diagram showing types of UWB parameters obtained from UWB signals, according to an embodiment of the present disclosure.

FIG. 8 is a diagram illustrating a process of calculating an angle-of-arrival (AoA) azimuth result value and an AoA elevation result value, according to an embodiment of the present disclosure.

FIG. 9 is a diagram illustrating an antenna arrangement of a robot cleaner and a charger, according to an embodiment of the present disclosure.

FIG. 10 is a block diagram illustrating a structure of a robot cleaner according to an embodiment of the present disclosure.

FIG. 11 is a diagram illustrating a process of identifying the position of a robot cleaner in a case in which two UWB antennas are arranged on a charger, according to an embodiment of the present disclosure.

FIG. 12 is a diagram illustrating a process of identifying the position of a robot cleaner in a case in which two UWB antennas are arranged on a charger, according to an embodiment of the present disclosure.

FIG. 13 is a diagram illustrating a configuration for determining line of sight (LoS) by using an infrared (IR) signal, according to an embodiment of the present disclosure.

FIG. 14 is a diagram showing a process of identifying the position of a robot cleaner based on an IR signal and a UWB signal, according to an embodiment of the present disclosure.

FIG. 15 is a diagram showing a process to be performed when position determination is suspended, according to an embodiment of the present disclosure.

FIG. 16 is a diagram illustrating a configuration in which a robot cleaner communicates with a reference UWB device, according to an embodiment of the present disclosure.

FIG. 17 is a diagram illustrating a process of determining a final position by using a reference UWB device when position determination is suspended, according to an embodiment of the present disclosure.

FIG. 18 is a flowchart for describing a docking operation according to an embodiment of the present disclosure.

FIG. 19 is a diagram illustrating a plurality of IR signals output from a charger, according to an embodiment of the present disclosure.

FIG. 20 is a diagram showing a process of determining a movement direction based on a UWB measurement result and an IR signal measurement result, according to an embodiment of the present disclosure.

FIG. 21 is a diagram illustrating a robot cleaner performing a docking operation, according to an embodiment of the present disclosure.

FIG. 22 is a diagram showing criteria for determining the reliability of a UWB signal, according to an embodiment of the present disclosure.

FIG. 23 is a flowchart of a process of controlling a robot cleaner based on the reliability of a UWB signal, according to an embodiment of the present disclosure.

FIG. 24 is a block diagram illustrating a structure of a robot cleaner according to an embodiment of the present disclosure.

FIG. 25 is a flowchart of a process, performed by a robot cleaner, of determining a movement path, according to an embodiment of the present disclosure.

FIG. 26 is a diagram illustrating a structure of a robot cleaner according to an embodiment of the present disclosure.

### MODE FOR INVENTION

The present specification describes and discloses the principle of embodiments to clarify the scope of the present disclosure and to allow those of skill in the art to carry out the embodiments of the disclosure. The disclosed embodiments may be implemented in various forms.

Like reference numerals denote like elements throughout the present specification. The present specification does not describe all elements of embodiments, and general content in the art to which the present disclosure pertains or identical content between the embodiments will be omitted. A “module” or “unit” used herein may be implemented with software, hardware, firmware, or a combination thereof, and depending on embodiments, a plurality of “modules” or “units” may be implemented as one element, or one “module” or “unit” may include a plurality of elements.

In a description of an embodiment, a detailed description of relevant well-known techniques will be omitted when it unnecessarily obscures the gist of the present disclosure. In addition, ordinal numerals (e.g., ‘first’ or ‘second’) used in the description of the present disclosure are merely identifiers for distinguishing one element from another.

In addition, in the present disclosure, it should be understood that when components are “connected” or “coupled” to each other, the elements may be directly connected or coupled to each other, but may alternatively be connected or coupled to each other with an element therebetween, unless specified otherwise.

Terminology such as “at least one of A and B”, as may be used herein, includes any of the following: A, B, A and B. Terminology such as “at least one of A, B, and C”, as may be used herein, includes any of the following: A, B, C, A and B, A and C, B and C, A and B and C.

Similarly, terminology such as “at least one of A or B”, as may be used herein, includes any of the following: A, B, A and B. Terminology such as “at least one of A, B, or C”, as may be used herein, includes any of the following: A, B, C, A and B, A and C, B and C, A and B and C.

Hereinafter, various embodiments of the present disclosure and the operating principle thereof will be described with reference to the accompanying drawings.

Embodiments of the present disclosure aim to perform reliable homing and docking operations by using a robot cleaner having an ultra-wideband (UWB) communication function. Through this, the embodiments of the present disclosure are to increase the value and usability of smart home appliances by providing a high level of convenience to users.

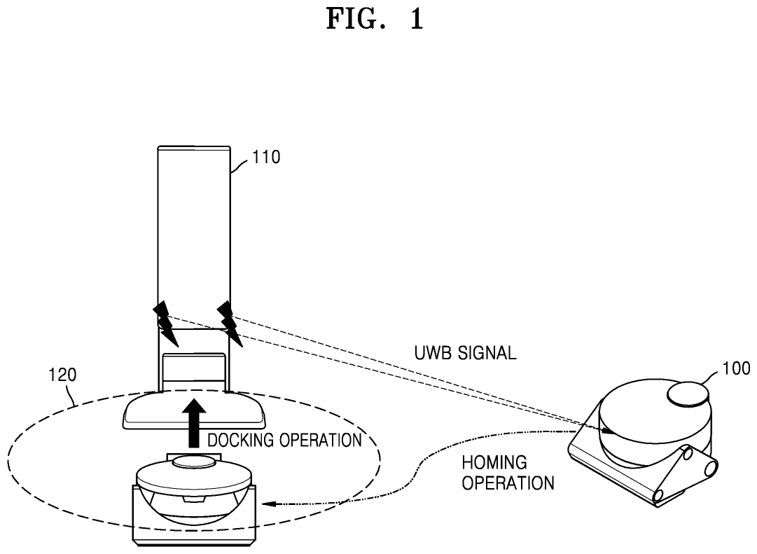

FIG. 1 is a diagram illustrating a robot cleaner and a charger according to an embodiment of the present disclosure.

A robot cleaner 100 includes a battery and operates by using power stored in the battery. Because the battery stores a certain amount of power, the robot cleaner 100 moves to a charger 110 when the charge of the battery falls below a reference value, docks with the charger 110, and then performs charging. In addition, the robot cleaner 100 stands by while docked with the charger 110, during an idle time after a cleaning operation is terminated.

An operation, performed by the robot cleaner 100, of terminating a cleaning operation and moving to the charger 110 is referred to as a homing operation. In addition, an operation, performed by the robot cleaner 100 in the vicinity of the charger 110, of moving such that a charging port of the robot cleaner 100 comes into contact with a charging port of the charger 110 is referred to as a docking operation.

When the robot cleaner 100 terminate a cleaning operation, the robot cleaner 100 initiates the homing operation to move toward the charger 110. According to an embodiment of the present disclosure, both the robot cleaner 100 and the charger 110 perform UWB communication. When the robot cleaner 100 initiates the homing operation, the robot cleaner 100 activates UWB communication. The robot cleaner 100 includes at least one UWB antenna. The charger 110 includes two or more UWB antennas. The robot cleaner 100 detects a plurality of UWB signals output from the two or more UWB antennas of the charger 110. The robot cleaner 100 obtains position information of the charger 110 and position information of the robot cleaner 100, based on the plurality of UWB signals. The robot cleaner 100 may calculate coordinate values of the charger 110 and coordinate values of the robot cleaner 100 in a certain three-dimensional coordinate system centered on the position of the charger 110.

The basis of UWB technology is the Institute of Electrical and Electronics Engineers (IEEE) 802.15.4/4z standard, which defines key characteristics for low-speed wireless connection and improved ranging capabilities. The robot cleaner 100 may obtain distance information and direction information between the charger 110 and the robot cleaner 100 by using payload information element (IE) content provided by the UWB standard. The robot cleaner 100 defines position information of each of the charger 110 and the robot cleaner 100 by using distance information and direction information with respect to the charger 110. The robot cleaner 100 performs the homing operation to move to the charger 110, based on the position information of the charger 110 and the position information of the robot cleaner 100.

The robot cleaner 100 performs the docking operation when it arrives a peripheral region 120 of the charger 110 by performing the homing operation.

According to an embodiment, the robot cleaner 100 measures the distance to the charger 110 based on a plurality of UWB signals output from the charger 110. When the distance to the charger 110 is within a reference value, the robot cleaner 100 determines that the robot cleaner 100 is within the peripheral region 120.

According to an embodiment, the charger 110 outputs an infrared (IR) signal. The robot cleaner 100 detects the IR signal output from the charger 110. The robot cleaner 100 determines whether the robot cleaner 100 is within a line of sight (LoS) of the charger 110, based on the detected IR signal. When it is determined that the robot cleaner 100 is within the LoS of the charger 110, the robot cleaner 100 determines that the robot cleaner 100 is within the peripheral region 120.

According to embodiments of the present disclosure, because the position information of the robot cleaner 100 and the charger 110 in a three-dimensional coordinate system is obtained based on UWB signals, and the homing operation is controlled based on the position information, the homing operation may be performed even when the position of the robot cleaner 100 or the charger 110 is changed during operation.

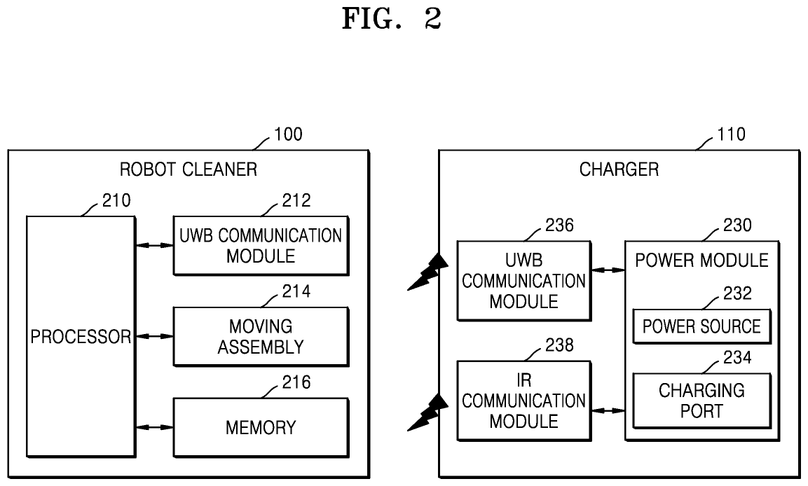

FIG. 2 is a block diagram illustrating structures of a robot cleaner and a charger, according to an embodiment of the present disclosure.

The robot cleaner 100 according to an embodiment of the present disclosure has a traveling function and a cleaning function. The robot cleaner 100 performs cleaning wirelessly while traveling in a space to be cleaned. The robot cleaner 100 includes a battery. The robot cleaner 100 connects to the charger 110 to perform charging.

The robot cleaner 100 includes a processor 210, a UWB communication module 212, a moving assembly 214, and a memory 216.

The processor 210 controls the overall operation of the robot cleaner 100. The processor 210 may include one or more processors. The processor 210 may execute instructions or commands stored in the memory 216 to perform a certain operation.

The UWB communication module 212 generates a UWB signal and detects a UWB signal. The UWB communication module 212 includes at least one UWB antenna. According to an embodiment, the UWB communication module 212 may include one UWB antenna. The UWB communication module 212 performs analog-to-digital conversion on a UWB signal detected by the UWB antenna. In addition, the UWB communication module 212 delivers the UWB signal converted into a digital signal, to the processor 210 or the memory 216.

The UWB communication module 212 receives a plurality of UWB signals output from the charger 110. The charger 110 includes two or three UWB antennas and may output two or three UWB signals. The UWB communication module 212 of the robot cleaner 100 detects each of the two or three UWB signals output from the charger 110.

UWB is a short-range radio-frequency (RF) communication technology for measuring a distance at an accuracy of several centimeters by using a wideband frequency of 500 MHz or higher and a pulse with a length of about 2 nanoseconds (one nanosecond is one billionth of a second). UWB enables transmission and reception at low power over a wide frequency band, thus hardly interferes with other wireless technologies, and thus may be used together with other wireless technologies such as near-field communication (NFC), Bluetooth, or Wi-Fi. UWB technology is known for its excellent performance such as accuracy, power consumption, wireless connection stability, and security in a complex environment in which people are crowded, such as parking lots, hospitals, or airports.

The moving assembly 214 moves the robot cleaner 100. The moving assembly 214 may be arranged on the lower surface of the robot cleaner 100 to cause the robot cleaner 100 to move forward and backward, and rotate. The moving assembly 214 may include a pair of wheels respectively arranged on left and right edges with respect to a central area of the main body of the robot cleaner 100. In addition, the moving assembly 214 may include a wheel motor to apply a moving force to each wheel, and a caster wheel installed in a front portion of the main body to rotate and change its angle according to the state of a floor surface on which the robot cleaner 100 moves. The pair of wheels may be symmetrically arranged in the main body of the robot cleaner 100.

The processor 210 controls traveling of the robot cleaner 100 by controlling the moving assembly 214. The processor 210 sets a travel path of the robot cleaner 100 based on cleaning map information. In addition, the processor 210 drives the moving assembly 214 such that the robot cleaner 100 moves along the travel path. To this end, the processor 210 generates a driving signal for controlling the moving assembly 214, and outputs the driving signal to the moving assembly 214. The moving assembly 214 drives each component of the moving assembly 214 based on the driving signal output from the processor 210.

In addition, the processor 210 controls the moving assembly 214 to control a homing operation and a docking operation of the robot cleaner 100. The processor 210 determines a movement direction of the robot cleaner 100 based on position information of the charger 110 and position information of the robot cleaner 100 that are determined based on a plurality of UWB signals output from the charger 110. In addition, the processor 210 controls the moving assembly 214 to move the robot cleaner 100 in the determined movement direction. In addition, the processor 210 determines a movement speed of the robot cleaner 100 during the homing operation and the docking operation. The processor 210 controls the moving assembly 214 to move the robot cleaner 100 according to the determined movement speed.

The memory 216 stores various pieces of information, data, instructions, programs, and the like necessary for an operation of the robot cleaner 100. The memory 216 may store map information.

The memory 216 may include at least one of volatile memory or non-volatile memory, or a combination thereof. The memory 216 may include at least one of a flash memory-type storage medium, a hard disk-type storage medium, a multimedia card micro-type storage medium, a card-type memory (e.g., SD or XD memory), random-access memory (RAM), static RAM (SRAM), read-only memory (ROM), electrically erasable programmable ROM (EEPROM), programmable ROM (PROM), magnetic memory, a magnetic disk, or an optical disc. In addition, the memory 216 may correspond to a web storage or a cloud server that performs a storage function on the Internet.

The charger 110 is connected to a power source and supplies power to the robot cleaner 100. The charger 110 and the robot cleaner 100 wirelessly communicate with each other, and are connected to each other through a charging port (not shown) of the robot cleaner 100 and a charging port 234 of the charger 110. The charger 110 is placed at a certain position in a cleaning area.

The charger 110 includes a power module 230, a UWB communication module 236, and an IR communication module 238.

The power module 230 is connected to an external power source and supplies power to the robot cleaner 100. The power module 230 may include a power source 232 and the charging port 234. The power source 232 is connected to an external power source and supplies power. The charging port 234 is a port to output the power supplied from the power source 232. When the charging port of the robot cleaner 100 is connected to the charging port 234 of the charger 110, the charger 110 supplies power to the robot cleaner 100.

The UWB communication module 236 generates and outputs a UWB signal. The UWB communication module 236 includes a plurality of UWB antennas. The UWB communication module 236 generates a plurality of UWB signals corresponding to the plurality of UWB antennas, respectively. Each of the plurality of UWB antennas generates and outputs a UWB signal. The UWB signals output from the plurality of UWB antennas include timestamp information.

The IR communication module 238 generates and outputs an IR signal. IR communication is a communication method using IR signals with a wavelength ranging from 780 nm to 1 mm. IR communication is used for short-range communication and, for example, may correspond to an Infrared Data Association (IrDA) method. The IR communication module 238 is a communication module using IR communication. The IR communication module 238 may generate and output a plurality of types of IR signals. The IR communication module 238 may include an IR-emitting diode (IRED), a phototransistor, an IR receiver module, an IR transmitter circuit, an IR receiver circuit, or the like.

The charger 110 outputs an IR signal from the IR communication module 238 to inform the robot cleaner 100 that the charger 110 is at a corresponding position. The robot cleaner 100 detects the IR signal and recognizes that the charger 110 is nearby. The robot cleaner 100 may perform the docking operation in the peripheral region 120 of the charger 110 based on the IR signal.

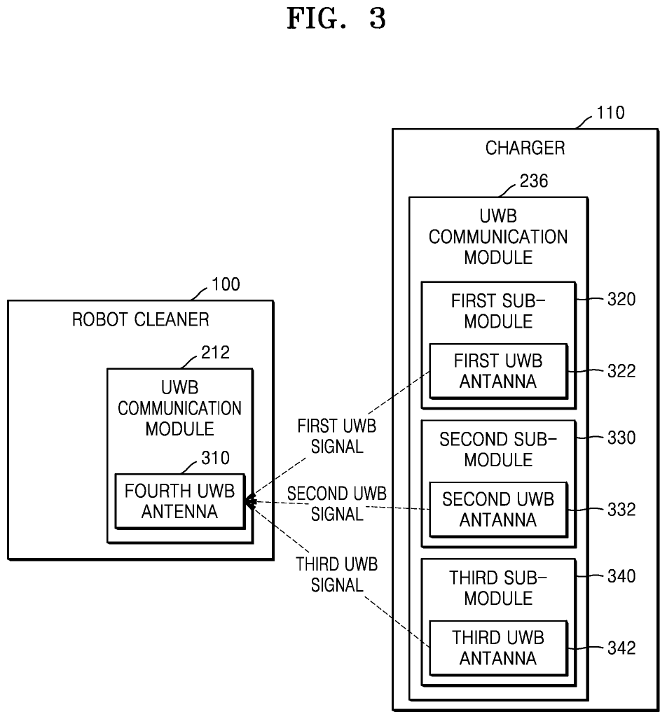

FIG. 3 is a diagram illustrating UWB communication modules of a robot cleaner and a charger, according to an embodiment of the present disclosure.

The robot cleaner 100 includes the UWB communication module 212, and the charger 110 includes the UWB communication module 236. The charger 110 includes a plurality of sub-modules 320, 330, and 340. According to an embodiment, the charger 110 includes two sub-modules 320 and 330. According to an embodiment, the charger 110 includes three sub-modules 320, 330, and 340. An embodiment in which the UWB communication module 236 of the charger 110 includes three sub-modules 320, 330, and 340 is mainly described with reference to FIG. 3, but embodiments of the present disclosure are not limited thereto.

The UWB communication module 212 of the robot cleaner 100 includes a fourth UWB antenna 310. In addition, the UWB communication module 212 may include a signal modulation circuit, a signal detection circuit, an analog-to-digital conversion circuit, a digital-to-analog conversion circuit, an amplification circuit, and the like. The fourth antenna 310 receives UWB signals from a first UWB antenna 322, a second UWB antenna 332, and a third UWB antenna 342 of the UWB communication module 236 of the charger 110.

The UWB communication module 236 of the charger 110 includes a first sub-module 320, a second sub-module 330, and a third sub-module 340. The first sub-module 320 includes the first UWB antenna 322. The second sub-module 330 includes the second UWB antenna 332. The third sub-module 340 includes the third UWB antenna 342. Each of the first sub-module 320, the second sub-module 330, and the third sub-module 340 may include a signal modulation circuit, a signal detection circuit, an analog-to-digital conversion circuit, a digital-to-analog conversion circuit, an amplification circuit, and the like.

The first sub-module 320 of the charger 110 generates a first UWB signal and outputs the first UWB signal through the first UWB antenna 322. The second sub-module 330 of the charger 110 generates a second UWB signal and outputs the second UWB signal through the second UWB antenna 332. The third sub-module 340 of the charger 110 generates a third UWB signal and outputs the third UWB signal through the third UWB antenna 342. The first UWB signal, the second UWB signal, and the third UWB signal may have different identification information. The robot cleaner 100 may detect each of the first UWB signal, the second UWB signal, and the third UWB signal by using the identification information included in the respective signals.

The first UWB signal, the second UWB signal, and the third UWB signal include timestamp information. The timestamp information is information about a time point at which each signal is transmitted.

According to an embodiment, the first UWB antenna 322, the second UWB antenna 332, and the third UWB antenna 342 are arranged at the same height from the bottom of the charger 110.

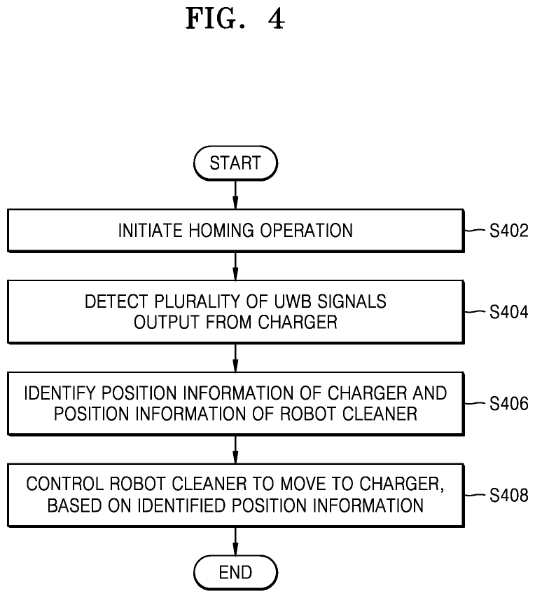

FIG. 4 is a flowchart of a robot cleaner control method according to an embodiment of the present disclosure.

The robot cleaner control method according to an embodiment of the present disclosure may be performed by the robot cleaner 100. According to an embodiment, the robot cleaner control method may be performed by the charger 110. In the present disclosure, an embodiment in which the robot cleaner 100 performs the robot cleaner control method is mainly described, but embodiments of the present disclosure are not limited thereto.

In addition, the robot cleaner control method according to an embodiment of the present disclosure may be performed by various types of robot cleaners having a UWB communication function and connectable to a charger having a plurality of UWB antennas. Thus, embodiments described for the robot cleaner control method are applicable to the robot cleaner 100, and embodiments described for the robot cleaner 100 are applicable to the robot cleaner control method.

In operation S402, the robot cleaner 100 initiates a homing operation. The robot cleaner 100 may initiate the homing operation when a cleaning operation is completed or when the remaining charge of the battery falls below a reference value. During the cleaning operation, the robot cleaner 100 may set a path for a cleaning operation based on map information. In addition, the robot cleaner 100 includes a sensor (e.g., an image sensor, a light detection and ranging (LiDAR) sensor, or an ultrasonic sensor) configured to recognize an obstacle, and may set a path for a cleaning operation based on recognized obstacles. When the robot cleaner 100 terminates the cleaning operation and initiates the homing operation, the robot cleaner 100 activates UWB communication. To activate UWB communication, the processor 210 of the robot cleaner 100 supplies power to the UWB communication module 212 and outputs a driving signal.

Next, in operation S404, the robot cleaner 100 detects a plurality of UWB signals output from the charger 110. For example, the robot cleaner 100 detects a first UWB signal and a second UWB signal output from the charger 110. For example, the robot cleaner 100 detects a first UWB signal, a second UWB signal, and a third UWB signal output from the charger 110.

Next, in operation S406, the robot cleaner 100 identifies position information of the charger 110 and position information of the robot cleaner 100 based on the plurality of detected UWB signals. The robot cleaner 100 may calculate the distance between a UWB antenna of the robot cleaner 100 and a UWB antenna of the charger 110, based on the plurality of UWB signals. The robot cleaner 100 identifies a time of arrival at which the first UWB signal reaches at the fourth UWB antenna 310 of the robot cleaner 100. The robot cleaner 100 calculates a time-of-flight (ToF) value based on the timestamp information and the time of arrival of the first UWB signal. The robot cleaner 100 calculates a first distance between the fourth UWB antenna 310 and the first UWB antenna 322 based on the ToF value of the first UWB signal. In a similar manner, the robot cleaner 100 calculates a second distance between the fourth UWB antenna 310 and the second UWB antenna 332 based on the second UWB signal. In addition, in a similar manner, the robot cleaner 100 calculates a third distance between the fourth UWB antenna 310 and the third UWB antenna 342 based on the third UWB signal.

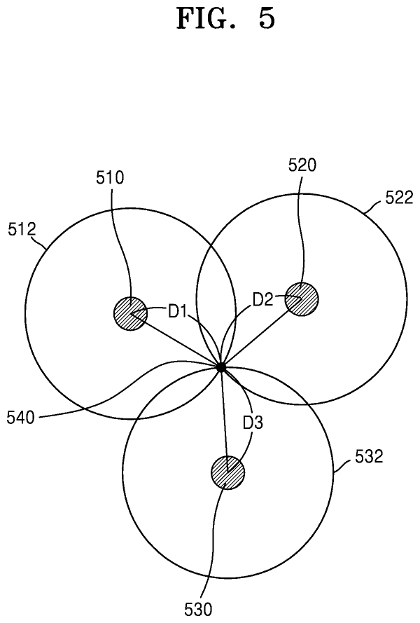

The robot cleaner 100 identifies the position information of the robot cleaner 100 and the position information of the charger 110 based on the first distance, the second distance, and the third distance. A process of identifying the position information of the robot cleaner 100 and the position information of the charger 110 will be described with reference to FIG. 5.

FIG. 5 is a diagram for describing a process of identifying position information of a robot cleaner and position information of a charger, according to an embodiment of the present disclosure.

As described above, the robot cleaner 100 calculates a first distance D1, a second distance D2, and a third distance D3 by using a plurality of UWB signals. The robot cleaner 100 calculates coordinates of the robot cleaner 100 in a coordinate system in which positions of the first UWB antenna 322, the second UWB antenna 332, and the third UWB antenna 342 of the charger 110 are defined. The robot cleaner 100 defines a first circle 512 centered on coordinates of the first UWB antenna 322 and having a radius equal to the first distance D1. In addition, the robot cleaner 100 defines a second circle 522 centered on coordinates of the second UWB antenna 332 and having a radius equal to the second distance D2. In addition, the robot cleaner 100 defines a third circle 532 centered on coordinates of the third UWB antenna 342 and having a radius equal to the third distance D3. The robot cleaner 100 defines a contact point 540 of the first circle 512, the second circle 522, and the third circle 532, as the coordinates of the robot cleaner 100.

A subsequent operation will be described with reference to FIG. 4.

In operation S408, the robot cleaner 100 controls the robot cleaner 100 to move to the charger 110, based on the position information of the charger 110 and the position information of the robot cleaner 100. The robot cleaner 100 sets a direction in which to move to the charger 110, based on the position information of the robot cleaner 100 and the position information of the charger 110. However, it is impossible to obtain information about obstacles, such as walls or furniture, by using only the position information. Thus, the robot cleaner 100 detects an obstacle by using a detection value of the sensor, and sets a movement path to avoid the obstacle.

The processor 210 of the robot cleaner 100 controls the moving assembly 214 to move the robot cleaner 100 according to the determined movement path in the homing operation. The robot cleaner 100 moves to the charger 110 by performing the homing operation.

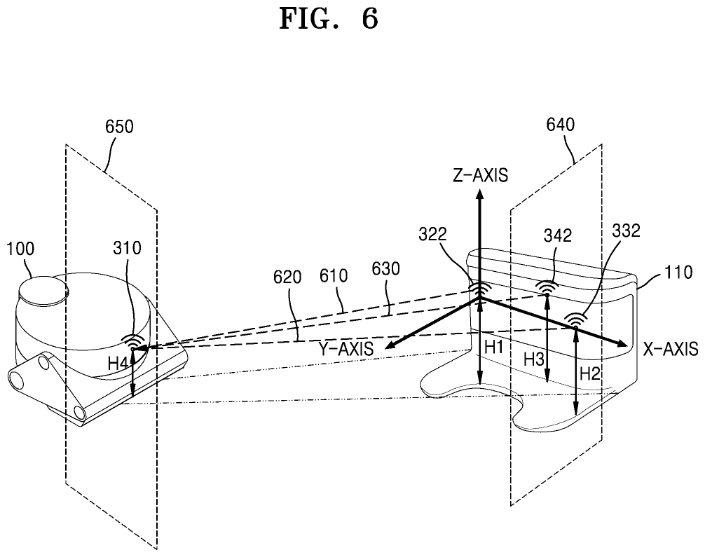

FIG. 6 is a diagram illustrating an antenna arrangement of a robot cleaner and a charger, according to an embodiment of the present disclosure.

According to an embodiment of the present disclosure, the robot cleaner 100 includes one UWB antenna, and the charger 110 includes three UWB antennas. The three UWB antennas of the charger 110 are arranged at the same height from the lower surface of the charger 110. The lower surface of the charger 110 refers to a surface in contact with a floor of a place where the charger 110 is installed (e.g., a bedroom or a living room). A surface formed by the three UWB antennas of the charger 110 is parallel or substantially parallel to the lower surface of the charger 110.

The charger 110 includes the first UWB antenna 322, the second UWB antenna 332, and the third UWB antenna 342. The first UWB antenna 322 is arranged at a first height H1 from the lower surface of the charger 110. The second UWB antenna 332 is arranged at a second height H2 from the lower surface of the charger 110. The third UWB antenna 342 is arranged at a third height H3 from the lower surface of the charger 110. The first height H1, the second height H2, and the third height H3 are equal to each other.

According to an embodiment, the first UWB antenna 322 and the second UWB antenna 332 are arranged on both sides of the front surface of the charger 110. For example, the first UWB antenna 322 and the second UWB antenna 332 may be arranged inside the front surface of the charger 110. Here, the front surface of the charger 110 refers to a surface on which the charging port 234 is arranged. The first UWB antenna 322 and the second UWB antenna 332 are arranged to be spaced apart from a vertical center plane 640 of the front surface of the charger 110 by the same distance. That is, the first UWB antenna 322 and the second UWB antenna 332 are arranged symmetrically with respect to the vertical center plane 640 of the front surface of the charger 110.

The third UWB antenna 342 is arranged on the vertical center plane 640. In addition, the third UWB antenna 342 is arranged to form a triangle with the first UWB antenna 322 and the second UWB antenna 332, and arranged on the vertical center plane 640. That is, the third UWB antenna 342 is arranged to deviate from a first straight line connecting the first UWB antenna 322 to the second UWB antenna 332, rather than on the first straight line.

The robot cleaner 100 includes the fourth UWB antenna 310. The fourth UWB antenna 310 is arranged on the front surface of the robot cleaner 100. For example, the fourth UWB antenna 310 is arranged inside the front surface of the robot cleaner 100. The fourth UWB antenna 310 may be arranged on a vertical center plane 650 of the robot cleaner 100.

The fourth UWB antenna 310 is arranged at a fourth height H4 from the lower surface of the robot cleaner 100. The lower surface of the robot cleaner 100 refers to a surface of the robot cleaner 100 to come into contact with a floor.

According to an embodiment of the present disclosure, the fourth height H4 may be different from the first height H1, the second height H2, and the third height H3. According to an embodiment of the present disclosure, the fourth height H4 may be equal to the first height H1, the second height H2, and the third height H3. Depending on whether the fourth height H4 is equal to the first height H1, the second height H2, and the third height H3, a method of calculating reliability information of UWB measurement may vary. Measurement of reliability of UWB measurement will be described in detail below.

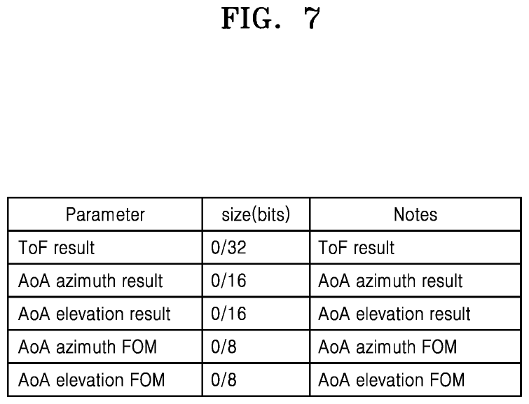

FIG. 7 is a diagram showing types of UWB parameters obtained from UWB signals, according to an embodiment of the present disclosure.

The robot cleaner 100 calculates a plurality of parameters based on a UWB signal received from the charger 110. The processor 210 of the robot cleaner 100 calculates values of parameters of a Payload IE Content field of a Ranging Result Report Message defined in the UWB standard, by using a plurality of UWB signals received from the UWB communication module 212. The processor 210 may execute instructions related to a UWB service to calculate parameters defined in the UWB standard.

The processor 210 calculates a ToF value for each of the plurality of UWB signals. The processor 210 may calculate distance information corresponding to each UWB signal by using the ToF value. For example, the processor 210 calculates a first distance corresponding to a first UWB signal, a second distance corresponding to a second UWB signal, and a third distance corresponding to a third UWB signal, by using ToF values of the respective UWB signals.

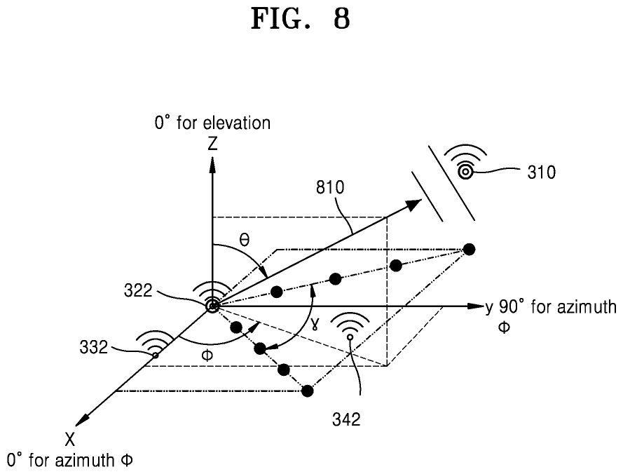

The processor 210 calculates an angle-of-arrival (AoA) azimuth result value and an AoA elevation result value, based on the first distance, the second distance, and the third distance. A process of calculating an AoA azimuth result value and an AoA elevation result value will be described with reference to FIG. 8.

FIG. 8 is a diagram illustrating a process of calculating an AoA azimuth result value and an AoA elevation result value, according to an embodiment of the present disclosure.

According to an embodiment of the present disclosure, the robot cleaner 100 defines a coordinate system having an origin at the position of any one of a plurality of UWB antennas of the charger 110. According to an embodiment of the present disclosure, the position of any one of the first UWB antenna 322 and the second UWB antenna 332 arranged on the front surface of the charger 110 may be defined as the origin of the coordinate system. In the present disclosure, an example in which a coordinate system having an origin at the position of the first UWB antenna 322 is used will be mainly described.

The robot cleaner 100 uses the position of the first UWB antenna 322 as the origin. In addition, the robot cleaner 100 defines an axis passing through the first UWB antenna 322 and the second UWB antenna 332 as an x-axis. In addition, the robot cleaner 100 defines a plane formed by the first UWB antenna 322, the second UWB antenna 332, and the third UWB antenna 342, as an xy plane. The position of the fourth UWB antenna 310 of the robot cleaner 100 is defined as one set of coordinates on the coordinate system. In addition, the robot cleaner 100 defines a z-axis perpendicular to the xy plane.

An AoA azimuth result value ϕ is defined as an angle formed by the x-axis and a path 810 of a UWB signal of the fourth UWB antenna 310 that is projected onto the xy plane, and is referred to as an azimuth. An AoA elevation result value θ is defined as an angle formed by the z-axis and the path 810 of the UWB signal of the fourth UWB antenna 310, and is referred to as an elevation angle.

As described above with reference to FIG. 5, the robot cleaner 100 calculates a first distance, a second distance, and a third distance, defines a first circle, a second circle, and a third circle, and calculates coordinates of the fourth UWB antenna 310 in the coordinate system of FIG. 8.

Other parameters will be described with reference to FIG. 7.

An AoA azimuth figure of merit (FOM) is an AoA azimuth performance metric and represents a performance metric of expected accuracy of an AoA azimuth result value. An AoA azimuth FOM may be calculated based on a received scrambled timestamp sequence (STS). An AoA azimuth FOM value may be expressed as an unsigned integer. A high AoA azimuth FOM value indicates high reliability, and an AoA azimuth FOM value of zero indicates that the AoA azimuth FOM value is invalid.

An AoA elevation FOM is an AoA elevation angle performance metric and represents the performance metric of expected accuracy of an AoA elevation result. An AoA elevation FOM may be calculated based on a received STS. An AoA elevation FOM value may be expressed as an unsigned integer. A high AoA elevation FOM value indicates high reliability, and an AoA elevation FOM value of zero indicates that the AoA elevation FOM value is invalid. For an AoA azimuth FOM value and an AoA elevation FOM value to be meaningful, the AoA capability of a measurement device, including details of antenna array configuration, needs to be known.

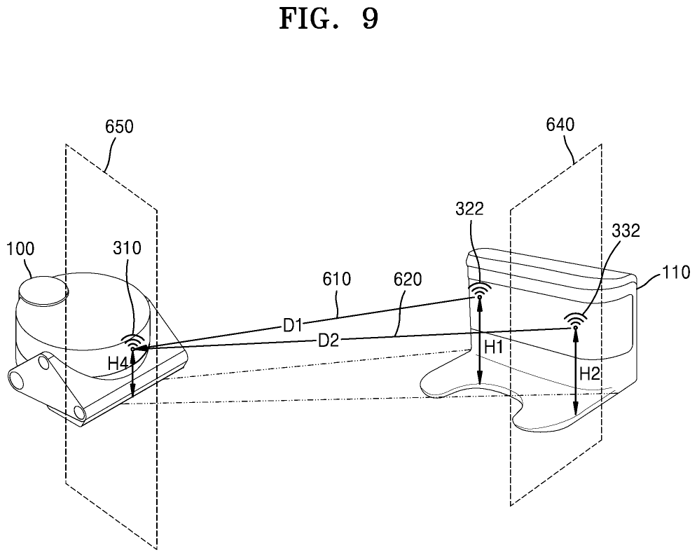

FIG. 9 is a diagram illustrating an antenna arrangement of a robot cleaner and a charger, according to an embodiment of the present disclosure.

According to an embodiment of the present disclosure, the robot cleaner 100 includes one UWB antenna, and the charger 110 includes two UWB antennas. The two UWB antennas of the charger 110 are arranged at the same height from the lower surface of the charger 110. The lower surface of the charger 110 refers to a surface in contact with a floor of a place where the charger 110 is installed (e.g., a bedroom or a living room). A surface formed by the two UWB antennas of the charger 110 is parallel or substantially parallel to the lower surface of the charger 110.

The charger 110 includes the first UWB antenna 322 and the second UWB antenna 332. The first UWB antenna 322 is arranged at a first height H1 from the lower surface of the charger 110. The second UWB antenna 332 is arranged at a second height H2 from the lower surface of the charger 110. The first height H1 and the second height H2 are equal to each other.

According to an embodiment, the first UWB antenna 322 and the second UWB antenna 332 are arranged on both sides of the front surface of the charger 110. For example, the first UWB antenna 322 and the second UWB antenna 332 may be arranged inside the front surface of the charger 110. Here, the front surface of the charger 110 refers to a surface on which the charging port 234 is arranged. The first UWB antenna 322 and the second UWB antenna 332 are arranged to be spaced apart from a vertical center plane 640 of the front surface of the charger 110 by the same distance. That is, the first UWB antenna 322 and the second UWB antenna 332 are arranged symmetrically with respect to the vertical center plane 640 of the front surface of the charger 110.

The robot cleaner 100 includes the fourth UWB antenna 310. The fourth UWB antenna 310 is arranged on the front surface of the robot cleaner 100. For example, the fourth UWB antenna 310 is arranged inside the front surface of the robot cleaner 100. The fourth UWB antenna 310 may be arranged on a vertical center plane 650 of the robot cleaner 100.

The fourth UWB antenna 310 is arranged at a fourth height H4 from the lower surface of the robot cleaner 100. The lower surface of the robot cleaner 100 refers to a surface of the robot cleaner 100 to come into contact with a floor.

According to an embodiment of the present disclosure, the fourth height H4 may be different from the first height H1 and the second height H2. According to an embodiment of the present disclosure, the fourth height H4 may be equal to the first height H1 and the second height H2. Depending on whether the fourth height H4 is equal to the first height H1 and the second height H2, a method of calculating reliability information of UWB measurement may vary. Measurement of reliability of UWB measurement will be described in detail below.

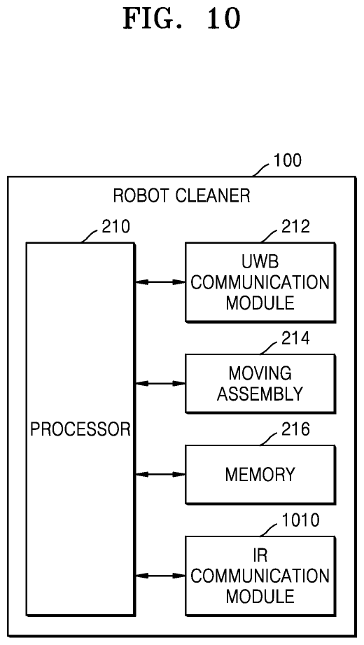

FIG. 10 is a block diagram illustrating a structure of a robot cleaner according to an embodiment of the present disclosure.

According to an embodiment of the present disclosure, the robot cleaner 100 includes the processor 210, the UWB communication module 212, the moving assembly 214, the memory 216, and an IR communication module 1010. The processor 210, the UWB communication module 212, the moving assembly 214, and the memory 216 of FIG. 10 are similar to those described above with reference to FIG. 2. Thus, the configuration of the robot cleaner 100 will be described with reference to FIG. 10, focusing on the difference from the embodiment of FIG. 2, and the IR communication module 1010.

The IR communication module 1010 generates and outputs an IR signal. The IR communication module 1010 is a communication module using IR communication. The IR communication module 1010 detects an IR signal output from the IR communication module 238 of the charger 110. The IR communication module 1010 includes an IR sensor, and detects an IR signal output from the IR communication module 238 of the charger 110 by using the IR sensor. The IR sensor of the IR communication module 1010 may include a phototransistor, an IR light receiving module, an IR receiver circuit, and the like. In addition, the IR communication module 1010 may include an IRED, an IR light receiving module, an IR receiver circuit, or the like.

The processor 210 identifies position information of the robot cleaner 100 based on the IR signal detected by the IR communication module 1010. The processor 210 may identify two candidate positions of the robot cleaner 100 based on two UWB signals output from the first UWB antenna 322 and the second UWB antenna 332 of the charger 110. However, the processor 210 is able to only identify the two candidate positions based on the two UWB signals, and is unable to identify where the robot cleaner 100 is located among the two candidate positions.

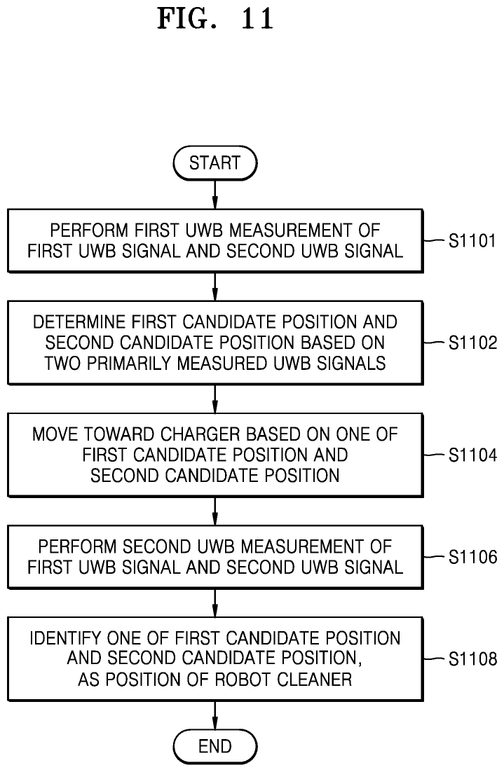

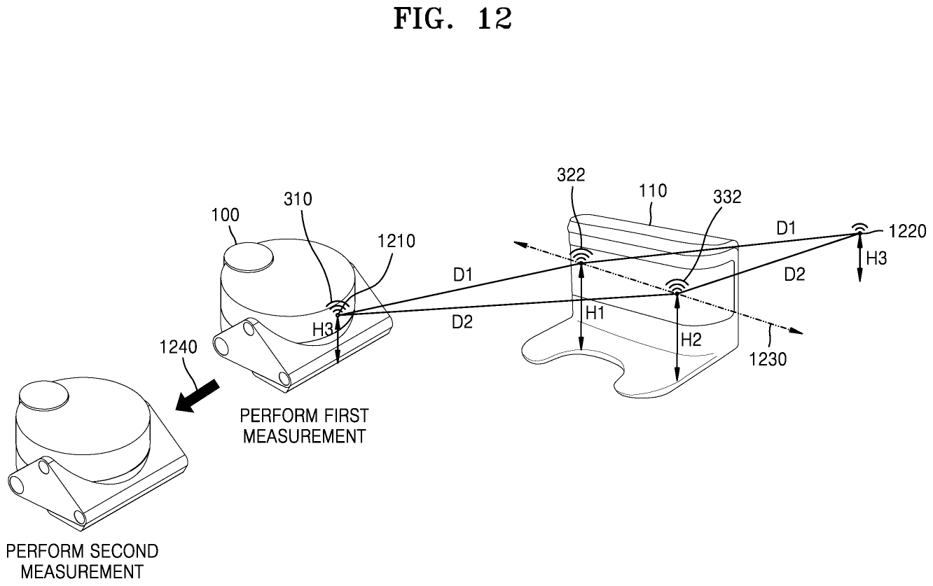

FIG. 11 is a diagram illustrating a process of identifying the position of a robot cleaner when two UWB antennas are arranged on a charger, according to an embodiment of the present disclosure. FIG. 12 is a diagram illustrating a process of identifying the position of a robot cleaner in a case in which two UWB antennas are arranged on a charger, according to an embodiment of the present disclosure. A process, performed by the robot cleaner 100, of identifying the position of the robot cleaner will be described with reference to FIGS. 11 and 12.

In operation S1101, the robot cleaner 100 performs first UWB measurement of a first UWB signal output from the first UWB antenna 322 of the charger 110 and a second UWB signal output from the second UWB antenna 332 of the charger 110. In the first UWB measurement, the robot cleaner 100 obtains a parameter value indicating whether the UWB measurement is LoS. By referring to an NLoS value in a Payload field of ‘Two Way ranging Measurement result’ of Fira UWB UCI, it is possible to identify whether the UWB measurement is LoS. That is, a UWB service performs Two Way Ranging Measurement and generates and outputs an NLos value. The processor 210 may determine whether the first UWB signal and the second UWB signal are LoS or not, based on an NLoS value.

In operation S1102, the robot cleaner 100 determines a first candidate position 1210 and a second candidate position 1220 of the robot cleaner 100 based on the first UWB signal and the second UWB signal of the first UWB measurement.

As described above, in a case in which two UWB antennas are arranged on the charger 110, the position of the robot cleaner 100 is identified as one of two candidate positions. The robot cleaner 100 may determine that the robot cleaner 100 is located at the first candidate position 1210 or the second candidate position 1220, by using two UWB signals. The first candidate position 1210 and the second candidate position 1220 are symmetrical to each other with respect to a straight line 1230 connecting the first UWB antenna 322 of the charger 110 to the second UWB antenna 332 of the charger 110.

Next, in operation S1104, the robot cleaner 100 moves toward the charger 110 based on one of the first candidate position and the second candidate position. Here, the robot cleaner 100 may determine a direction to the charger 110 based on one of the first candidate position 1210 and the second candidate position 1220. For example, the robot cleaner 100 determines the first candidate position 1210 and the second candidate position 1220 based on the first UWB measurement, and moves toward the charger 110 based on the second candidate position 1220.

The distance traveled by the robot cleaner 100 may be a predetermined distance. According to an embodiment, in operation S1104, the robot cleaner 100 may move a predetermined distance of approximately several tens of centimeters.

Next, in operation S1106, the robot cleaner 100 moves toward the charger 110 (1240) and then performs second UWB measurement to measure the first UWB signal and the second UWB signal. In the second UWB measurement, the robot cleaner 100 obtains a parameter value indicating whether the UWB measurement is LoS. The processor 210 may determine whether the first UWB signal and the second UWB signal are LoS, based on an NLoS value of the second UWB measurement.

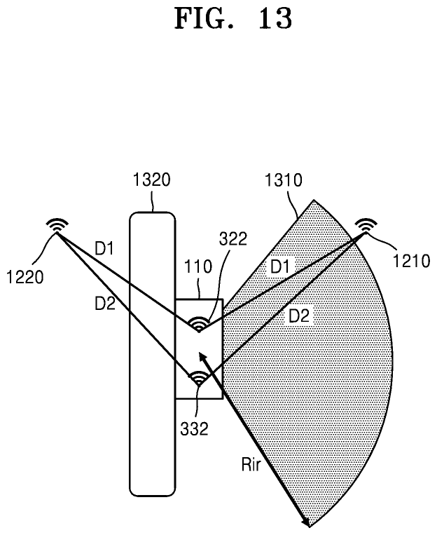

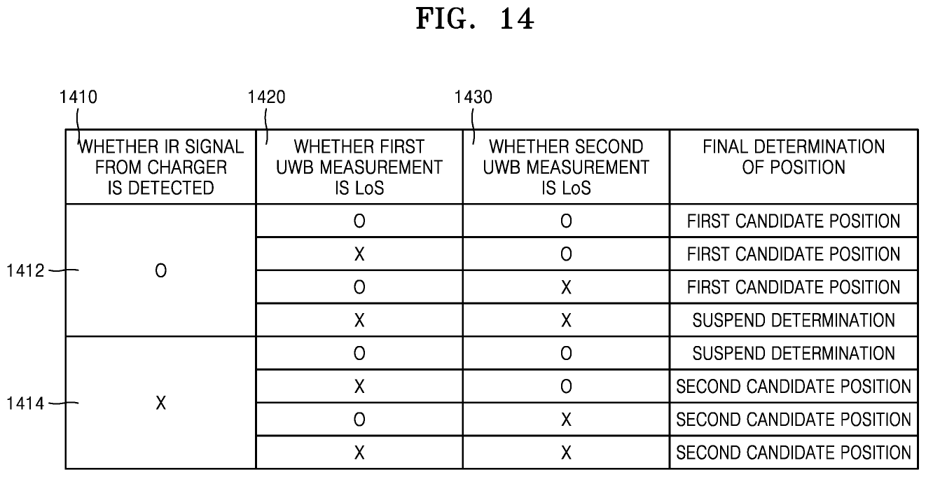

Next, in operation S1108, the robot cleaner 100 identifies one of the first candidate position and the second candidate position, as the position of the robot cleaner 100. In general, the charger 110 of the robot cleaner 100 is arranged such that the rear thereof faces a wall. Thus, the robot cleaner 100 may identify one of the first candidate position 1210 and the second candidate position 1220 as the position of the robot cleaner 100, assuming that the rear of the charger 110 is in contact with a wall. A process of identifying one of the first candidate position 1210 and the second candidate position 1220 as the position of the robot cleaner 100 will be described with reference to FIGS. 13 and 14.

FIG. 13 is a diagram illustrating a configuration for determining LoS by using an IR signal, according to an embodiment of the present disclosure.

The charger 110 is arranged adjacent to a certain wall 1320. The wall 1320 may correspond to various forms, such as a concrete wall, a furniture wall, or a partition.

The charger 110 includes the IR communication module 238 and outputs an IR signal. The IR communication module 238 outputs an IR signal from the front surface of the charger 110 on which the charging port 234 is arranged. The IR signal has an IR signal propagation range 1310 with a certain radius Rir. The robot cleaner 100 may detect an IR signal within the IR signal propagation range 1310, and may not detect an IR signal outside the IR signal propagation range 1310.

IR signals rarely pass through obstacles. Thus, an IR signal is detected by the robot cleaner 100 only within the LoS of the charger 110. The robot cleaner 100 cannot detect an IR signal when the robot cleaner 100 is outside the LoS of the charger 110. Thus, the robot cleaner 100 may determine whether the charger 110 is within the LoS, by detecting an IR signal.

When the robot cleaner 100 is located at the first candidate position 1210, the robot cleaner 100 is within the LoS of the charger 110, and thus may detect an IR signal. When the robot cleaner 100 is located at the second candidate position 1220, the wall 1320 is between the robot cleaner 100 and the charger 110. Thus, the IR signal output from the charger 110 is blocked by the wall 1320. The robot cleaner 100 cannot detect the IR signal and determines that the robot cleaner 100 is outside the LoS of the charger 110.

FIG. 14 is a diagram showing a process of identifying the position of a robot cleaner based on an IR signal and a UWB signal, according to an embodiment of the present disclosure.

According to an embodiment of the present disclosure, the robot cleaner 100 may identify one of the first candidate position and the second candidate position as the position of the robot cleaner 100, based on a result of detecting an IR signal and whether two UWB signals are LoS.

The robot cleaner 100 determines whether the IR signal of the charger 110 has been detected (1410). In addition, the robot cleaner 100 obtains an LoS value of a UWB signal in the first UWB measurement and obtains an LoS value of a UWB signal in the second UWB measurement. The robot cleaner 100 determines whether the first UWB measurement is LoS (1420), based on the LoS value of the first UWB measurement. The robot cleaner 100 determines whether the second UWB measurement is LoS (1430) based on the LoS value of the second UWB measurement.

The robot cleaner 100 identifies the position of the robot cleaner 100 based on whether an IR signal is detected (1410), whether the first UWB measurement is LoS (1420), and whether the second UWB measurement is LoS (1430). The robot cleaner 100 sets a position within the LoS of the charger 110 as the first candidate position 1210, and sets a position outside the LoS of the charger 110 as the second candidate position 1220.

When the IR signal of the charger 110 is detected (1412) and it is determined that at least one of the first UWB measurement or the second UWB measurement is within the LOS, it is determined that the robot cleaner 100 is at the first candidate position 1210. In this case, because the LoS determination result based on the IR signal and the LoS determination result based on the UWB signal coincide, it is determined that the robot cleaner 100 is at the first candidate position 1210 that is within the LoS.

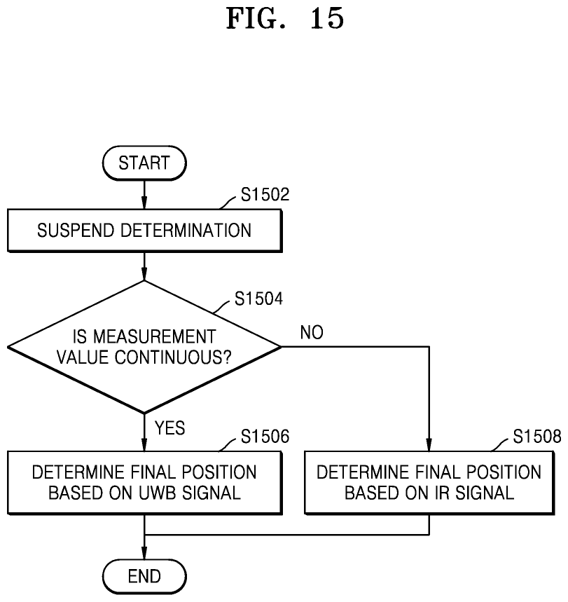

When the IR signal of the charger 110 is detected (1412) and it is determined that both the first UWB measurement and the second UWB measurement are outside the LoS, determination of the position of the robot cleaner 100 is suspended. In this case, because the LoS determination result based on the IR signal and the LoS determination result based on the UWB signal contradict each other, it is determined that the measurement is invalid. A process to be performed when the determination is suspended will be described in detail below with reference to FIG. 15.

When the IR signal of the charger 110 is not detected (1414) and it is determined that at least one of the first UWB measurement or the second UWB measurement is outside the LOS, it is determined that the robot cleaner 100 is at the second candidate position 1220. In this case, because the LoS determination result based on the IR signal and the LoS determination result based on the UWB signal coincide, it is determined that the robot cleaner 100 is at the second candidate position 1220 that is outside the LoS.

When the IR signal of the charger 110 is not detected (1414) and it is determined that both the first UWB measurement and the second UWB measurement are within the LoS, determination of the position of the robot cleaner 100 is suspended. In this case, because the LoS determination result based on the IR signal and the LoS determination result based on the UWB signal contradict each other, it is determined that the measurement is invalid. A process to be performed when the determination is suspended will be described in detail below with reference to FIG. 15.

FIG. 15 is a diagram showing a process to be performed when position determination is suspended, according to an embodiment of the present disclosure.

In operation S1502, the robot cleaner 100 determines to suspend determination of the final position from among the first candidate position and the second candidate position. The suspending of the determination corresponds to the case in which the determination is suspended described above with reference to FIG. 14.

In operation S1504, the robot cleaner 100 determines whether measurement values of the first UWB measurement and the second UWB measurement are continuous. The robot cleaner 100 may determine whether the measurement values of the first UWB measurement and the second UWB measurement are continuous, by determining whether there is an outlier among the measurement values. The robot cleaner 100 may determine whether there is an outlier among the UWB measurement values, by detecting pulse-shaped UWB measurement values, a UWB measurement value with a slope of a certain value or greater, or the like. The robot cleaner 100 may determine that the UWB measurement values are not continuous, even when only one of the first UWB measurement and the second UWB measurement is not continuous.

When the measurement values of the first UWB measurement and the second UWB measurement are continuous, in operation S1506, the robot cleaner 100 determines the final position based on the UWB signal. That is, the robot cleaner 100 determines the first candidate position 1210 as the final position when it is determined that at least one of the first UWB measurement or the second UWB measurement is within the LoS, and determines the second candidate position 1220 as the final position when it is determined that both the first UWB measurement and the second UWB measurement is outside the LoS.

When at least one of the first UWB measurement or the second UWB measurement is not continuous, in operation S1508, the robot cleaner 100 determines the final position based on the IR signal. That is, the robot cleaner 100 determines the first candidate position 1210 as the final position when the IR signal is detected, and determines the second candidate position 1220 as the final position when the IR signal is not detected.

According to an embodiment of the present disclosure, when the determination is suspended, the robot cleaner 100 determines the reliability of the UWB signal. An operation, performed by the robot cleaner 100, of determine the reliability of the UWB signal may be performed instead of operation S1504 of FIG. 15. When it is determined that the reliability is greater than a reference value, in operation S1506, the robot cleaner 100 determines the final position based on the UWB signal. When it is determined that the reliability is less than the reference value, in operation S1508, the robot cleaner 100 determines the final position based on the IR signal.

According to an embodiment of the present disclosure, when the determination is suspended, the robot cleaner 100 decreases the movement speed of the robot cleaner 100, and reduces the interval of UWB measurement to perform measurement more frequently. The robot cleaner 100 may reduce the interval of UWB measurement and perform the first UWB measurement and the second UWB measurement again. When performing UWB measurement again, the robot cleaner 100 may suspend the determination in operation S1502 and then determine the final position based on the table shown in FIG. 14 and a UWB remeasurement result. When it is determined to suspend the determination again based on the UWB remeasurement result, the robot cleaner 100 may perform the operations subsequent to operation S1504.

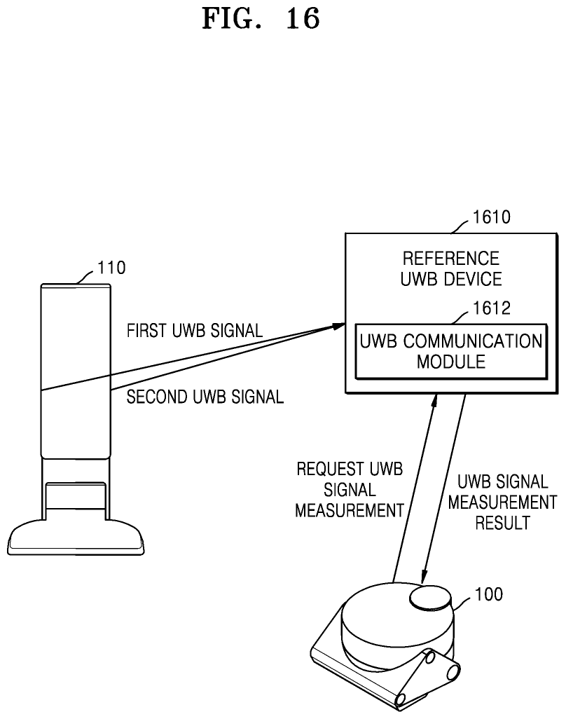

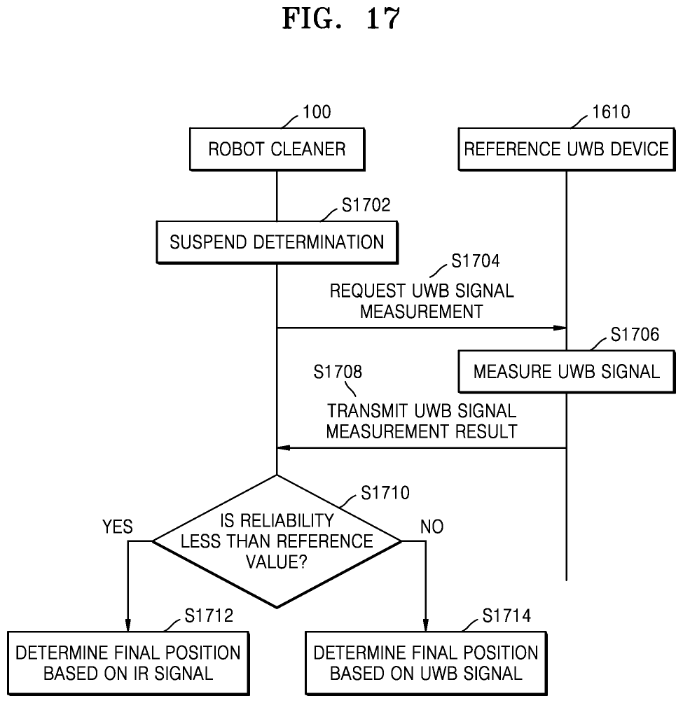

FIG. 16 is a diagram illustrating a configuration in which a robot cleaner communicates with a reference UWB device, according to an embodiment of the present disclosure. FIG. 17 is a diagram illustrating a process of determining a final position by using a reference UWB device when position determination is suspended, according to an embodiment of the present disclosure.

According to an embodiment of the present disclosure, when the determination of the final position is suspended in FIG. 14, the robot cleaner 100 may determine the final position by using a reference UWB signal output from a reference UWB device 1610.

The reference UWB device 1610 is a device for performing UWB communication. The reference UWB device 1610 includes a UWB communication module 1612. The reference UWB device 1610 receives and outputs UWB signals. The reference UWB device 1610 is a UWB device capable of AoA measurement. According to an embodiment, the reference UWB device 1610 performs AoA measurement by using a plurality of UWB signals received from the charger 110. When the reference UWB device 1610 performs AoA measurement by using UWB signals, the reference UWB device 1610 outputs a FOM value along with an AoA result report.

The reference UWB device 1610 may be implemented in the form of, for example, an artificial intelligence (AI) speaker, a television (TV), a refrigerator, a smart phone, a tablet personal computer (PC), an air purifier, an air conditioner, a smart tag, or a vehicle smart key.

In operation S1702, the robot cleaner 100 determines to suspend determination of the final position from among the first candidate position and the second candidate position. The suspending of the determination corresponds to the case in which the determination is suspended described above with reference to FIG. 14.

Next, in S1704, the robot cleaner 100 transmits a UWB signal measurement request to the reference UWB device 1610. The UWB signal measurement request is a signal for requesting AoA measurement from the reference UWB device 1610. The AoA measurement refers to measuring an AoA azimuth result, an AoA elevation result, an AoA azimuth FOM, and an AoA elevation FOM shown in FIG. 7, based on a UWB signal. The reference UWB device 1610 may perform AoA measurement based on a UWB signal output from the robot cleaner 100 or a UWB signal output from the charger 110.

Next, in operation S1706, the reference UWB device 1610 measures a UWB signal in response to the UWB signal measurement request. The reference UWB device 1610 detects a UWB signal output from the charger 110 or the robot cleaner 100, based on the UWB signal measurement request. In addition, the reference UWB device 1610 performs AoA measurement by using the detected UWB signal. According to an embodiment, the reference UWB device 1610 detects a first UWB signal and a second UWB signal output from the charger 110, and performs AoA measurement by using the first UWB signal and the second UWB signal. According to an embodiment, the reference UWB device 1610 detects a UWB signal output from the robot cleaner 100 and performs AoA measurement by using the detected UWB signal.

Next, in operation S1708, the reference UWB device 1610 transmits a UWB signal measurement result to the robot cleaner 100. The reference UWB device 1610 performs AoA measurement and transmits an AoA measurement result to the robot cleaner 100 as a UWB signal measurement result. The AoA measurement result includes at least one of an AoA azimuth FOM value or an AoA elevation FOM value.

Next, in operation S1710, the robot cleaner 100 determines whether the reliability of the UWB signal is less than a reference value. The robot cleaner 100 compares the AoA azimuth FOM value and the AoA elevation FOM value with reference values. The robot cleaner 100 may compare the AoA azimuth FOM value with a first reference value T1 and the AoA elevation FOM value with a second reference value T2. Here, T2 may be greater than T1. When the AoA azimuth FOM value is greater than T1 and the AoA elevation FOM value is greater than T2, the robot cleaner 100 determines that the reliability of the UWB signal is greater than or equal to the reference value. When the AoA azimuth FOM value is less than or equal to T1, or the AoA elevation FOM value is less than or equal to T2, the robot cleaner 100 determines that the reliability of the UWB signal is less than the reference value.

In operation S1712, when it is determined that the reliability of the UWB signal is less than the reference value, the robot cleaner 100 may determine the final position based on an IR signal. That is, the robot cleaner 100 determines the first candidate position 1210 as the final position when the IR signal is detected, and determines the second candidate position 1220 as the final position when the IR signal is not detected.

In operation S1714, when it is determined that the reliability of the UWB signal is greater than or equal to the reference value, the robot cleaner 100 determines the final position based on the UWB signal. That is, the robot cleaner 100 determines the first candidate position 1210 as the final position when it is determined that at least one of the first UWB measurement or the second UWB measurement is within the LoS, and determines the second candidate position 1220 as the final position when it is determined that both the first UWB measurement and the second UWB measurement is outside the LoS.

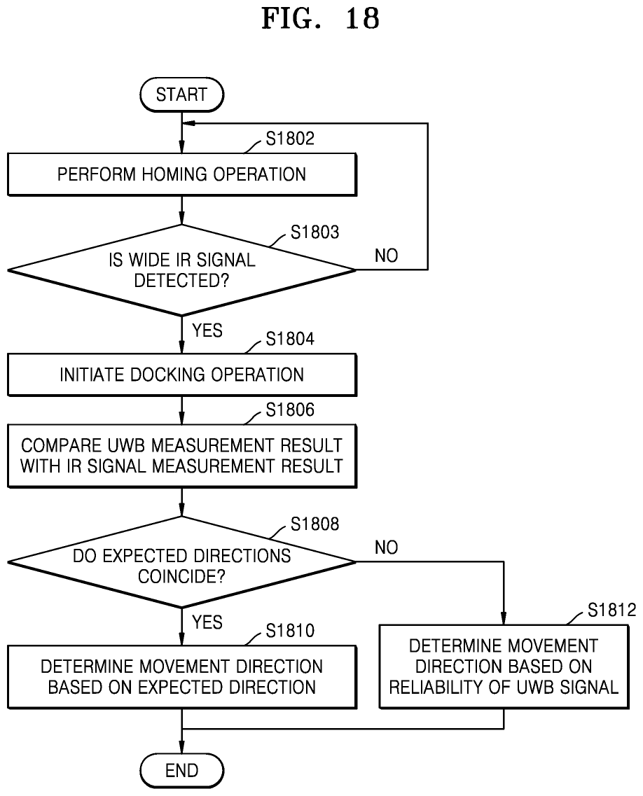

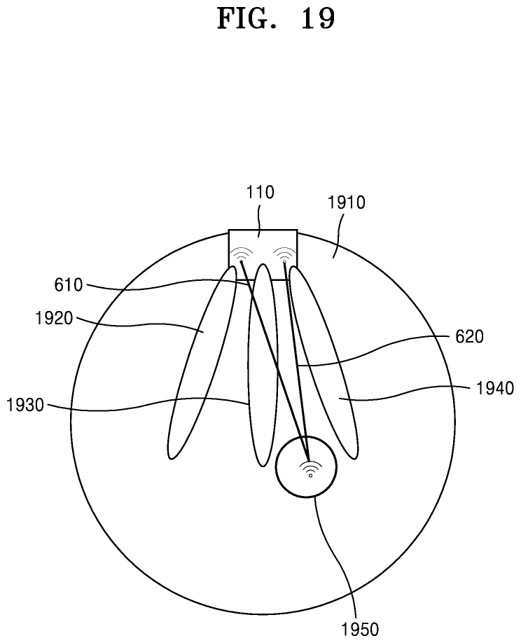

FIG. 18 is a flowchart for describing a docking operation according to an embodiment of the present disclosure. FIG. 19 is a diagram illustrating a plurality of IR signals output from a charger, according to an embodiment of the present disclosure.

According to an embodiment of the present disclosure, after completing the homing operation of moving to the vicinity of the charger 110, the robot cleaner 100 performs a docking operation. When the homing operation is completed, the robot cleaner 100 performs the docking operation of bringing the charging port of the robot cleaner 100 into contact with the charging port of the charger 110. When the docking operation is completed, the robot cleaner 100 receives power from the charger 110 and performs charging.

The robot cleaner 100 receives a first UWB signal 610 and a second UWB signal 620 from the charger 110 while performing the docking operation. In a case in which the charger 110 includes three UWB antennas, the robot cleaner 100 may receive the first UWB signal 610, the second UWB signal 620, and a third UWB signal 630 during the docking operation. In addition, the robot cleaner 100 receives IR signals 1910, 1920, 1930, and 1940 output from the charger 110, while performing the docking operation. The robot cleaner 100 at a current position 1950 receives the UWB signals 610 and 620 of the charger 110 and the IR signals 1910, 1920, 1930 and 1940 of the charger 110, to determine a current position and a movement direction.

The charger 110 outputs a wide IR signal 1910, a right IR signal 1920, a left IR signal 1940, and a center alignment IR signal 1930. The right IR signal 1920, the left IR signal 1940, and the center alignment IR signal 1930 are narrower signals than the wide IR signal 1910. The right IR signal 1920 is output from the charger 110 in the right direction. The left IR signal 1940 is output from the charger 110 in the left direction. The center alignment IR signal 1930 is output from the center of the charger 110 toward the front.

The right IR signal 1920 and the left IR signal 1940 may be detected by IR signal receivers arranged on the left and right sides of the robot cleaner 100. The center alignment IR signal 1930 may be detected by an IR signal receiver arranged on the front or rear of the robot cleaner 100. The center alignment IR signal 1930 is used to finely align the robot cleaner 100 in the left and right directions.

The wide IR signal 1910, the right IR signal 1920, the left IR signal 1940, and the center alignment IR signal 1930 may have different signal patterns. The robot cleaner 100 may recognize different signal patterns of the wide IR signal 1910, the right IR signal 1920, the left IR signal 1940, and the center alignment IR signal 1930, to identify each IR signal. The robot cleaner 100 detects an IR signal by using an IR sensor included in the IR communication module 1010. In addition, the robot cleaner 100 recognizes the signal pattern of the detected IR signal. Based on the recognized signal pattern, the robot cleaner 100 identifies which of the wide IR signal 1910, the right IR signal 1920, the left IR signal 1940, and the center alignment IR signal 1930 the detected IR signal corresponds to.

Next, a process, performed by the robot cleaner 100, of performing docking by using an IR signal will be described with reference to the flowchart of FIG. 18.

First, in operation S1802, the robot cleaner 100 performs a homing operation. Operation S1802 corresponds to operation S408 of FIG. 4.

When the homing operation is completed, in operation S1803, the robot cleaner 100 determines whether the wide IR signal 1910 output from the charger 110 is detected. The charger 110 outputs the wide IR signal 1910 having a certain propagation range. When the robot cleaner 100 is located within the propagation range of the wide IR signal 1910, the robot cleaner 100 may detect the wide IR signal 1910.

When the wide IR signal is not detected, the robot cleaner 100 continues the homing operation.

When the wide IR signal is detected, in operation S1804, the robot cleaner 100 initiates the docking operation. In the docking operation, the robot cleaner 100 may decrease the movement speed and reduce the interval of UWB signal measurement, compared to those in the homing operation.

Next, operations S1806, S1808, S1810, and S1812 will be described with reference to FIGS. 18, 20, and 21.

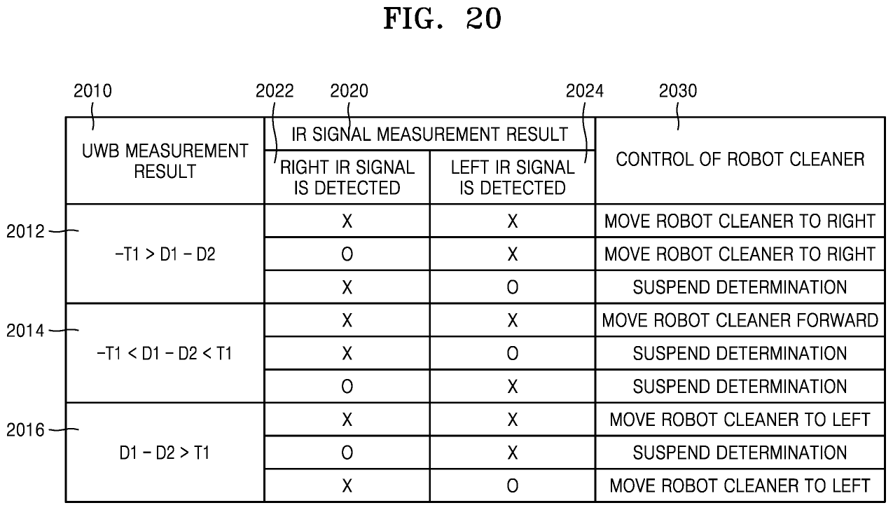

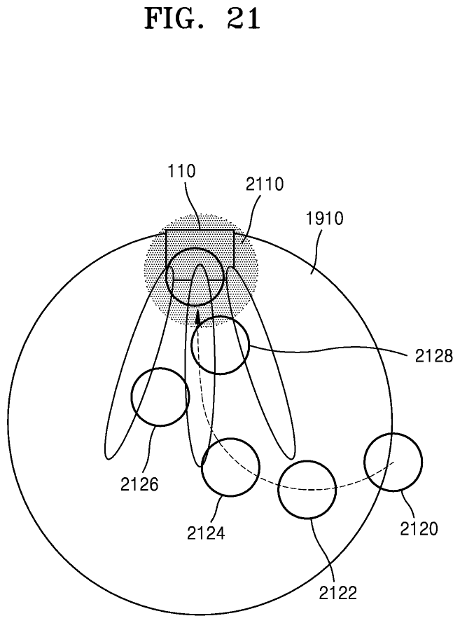

FIG. 20 is a diagram showing a process of determining a movement direction based on a UWB measurement result and an IR signal measurement result, according to an embodiment of the present disclosure. FIG. 21 is a diagram illustrating the robot cleaner 100 performing a docking operation, according to an embodiment of the present disclosure.

In operation S1806, the robot cleaner 100 compares a UWB measurement result 2010 with an IR signal measurement result 2020.

In operation S1808, the robot cleaner 100 determines whether directions expected from the UWB measurement result and the IR signal measurement result coincide, based on a result of comparing the two measurement results with each other. Operations S1806 and S1808 will be described with reference to FIGS. 20 and 21.

As shown in FIG. 20, the robot cleaner 100 may determine a movement direction of the robot cleaner based on a combination of the UWB measurement result 2010 and an IR signal measurement result 2020.

The UWB measurement result 2010 uses a first distance D1 measured based on the first UWB signal 610, and a second distance D2 measured based on the second UWB signal 620. The first UWB signal 610 is output from a right UWB antenna of the charger 110, and the second UWB signal 620 is output from a left UWB antenna of the charger 110. The first distance D1 denotes the distance from the right UWB antenna of the charger 110 to the UWB antenna of the robot cleaner 100. The second distance D2 denotes the distance from the left UWB antenna of the charger 110 to the UWB antenna of the robot cleaner 100.

The robot cleaner 100 determines a first expected direction of the robot cleaner 100 based on the UWB measurement result 2010. The UWB measurement result 2010 indicates whether the robot cleaner 100 is on the right or left side of the charger 110 when viewed from the charger 110, based on the UWB signals 610 and 620 output from the charger 110. The UWB measurement result 2010 may be obtained by comparing (D1−D2) with the reference value T1.

When (D1−D2) is less than −T1 (2012), the robot cleaner 100 determines that the robot cleaner 100 is on the right side when viewed from the charger 110. That is, when (D1-D2) is less than −T1 (2012), the first expected direction is defined as the right direction.

For example, a position 2126 of FIG. 21 may correspond to a case in which the robot cleaner 100 is on the right side.

When (D1-D2) is greater than −T1 and less than T1 (2014), the robot cleaner 100 determines that the robot cleaner 100 is in front of the charger 110. That is, when (D1−D2) is greater than −T1 and less than T1 (2014), the first expected direction is defined as the forward direction. For example, a position 2124 of FIG. 21 may correspond to a case in which the robot cleaner 100 is in front.

When (D1−D2) is greater than T1 (2016), the robot cleaner 100 determines that the robot cleaner 100 is on the left side of the charger 110. That is, when (D1−D2) is greater than T1 (2016), the first expected direction is defined as the left direction. For example, positions 2120, 2122, and 2128 in FIG. 21 may correspond to a case in which the robot cleaner 100 is on the left side.

Next, the IR signal measurement result 2020 will be described.

The robot cleaner 100 determines a second expected direction based on the IR signal measurement result 2020, based on whether the right IR signal 1920 and the left IR signal 1940 are detected. When both the right IR signal 1920 and the left IR signal 1940 are not detected, the robot cleaner 100 does not determine the second expected direction. When any one of the right IR signal 1920 and the left IR signal 1940 is detected, the robot cleaner 100 determines the second expected direction based on the detected IR signal.

The robot cleaner 100 compares the first expected direction with the second expected direction. When the second expected direction is not determined as both the right IR signal 1920 and the left IR signal 1940 are not detected, the robot cleaner 100 may determine that the first expected direction and the second expected direction coincide.

In the present disclosure, it is described that the robot cleaner 100 determines the first expected direction and the second expected direction, but the robot cleaner 100 may not define the first expected direction and the second expected direction as separate output values. That is, as shown in FIG. 20, the robot cleaner 100 may control the movement direction based on a combination of D1, D2, whether the right IR signal is detected (2022), and whether the left IR signal is detected (2024), and may not separately calculate the first expected direction and the second expected direction. The present disclosure includes an embodiment in which the first expected direction and the second expected direction are separately calculated, and an embodiment in which the first expected direction and the second expected direction are not separately calculated.

Next, when the first expected direction and the second expected direction coincide, in operation S1810, the robot cleaner 100 determines the movement direction of the robot cleaner 100 based on an expected direction. The expected direction is a direction corresponding to the first expected direction and the second expected direction.

Referring to FIG. 20, when the UWB measurement result 2010 corresponds to 2012, the robot cleaner 100 defines the first expected direction as the right direction. In addition, when the IR signal measurement result 2020 indicates that the right IR signal 1920 is detected and the left IR signal 1940 is not detected, the robot cleaner 100 determines the second expected direction based on the IR signal measurement result 2020 as the right direction. In this case, because the first expected direction and the second expected direction coincide, the robot cleaner 100 determines that the robot cleaner 100 is on the right side when viewed from the charger 110. Accordingly, the robot cleaner 100 moves to the right side of the charger 110. In addition, when the UWB measurement result 2010 corresponds to 2012 and the robot cleaner 100 does not detect both the right IR signal 1920 and the left IR signal 1940, the robot cleaner 100 determines the movement direction of the robot cleaner 100 according to the first expected direction. Accordingly, the robot cleaner 100 determines that the robot cleaner 100 is on the right side when viewed from the charger 110, and moves to the right.

When the UWB measurement result 2010 corresponds to 2014, the robot cleaner 100 defines the first expected direction as the forward direction. In addition, when the IR signal measurement result 2020 indicates that both the right IR signal 1920 and the left IR signal 1940 are not detected, the robot cleaner 100 cannot determine the second expected direction. Accordingly, the robot cleaner 100 determines the movement direction based on the first expected direction. The robot cleaner 100 determines that the robot cleaner 100 is in front when viewed from the charger 110, and moves forward.

According to an embodiment of the present disclosure, the robot cleaner 100 includes, in the IR signal measurement result 2020, whether the center alignment IR signal 1930 is detected. When the robot cleaner 100 does not detect both the right IR signal 1920 and the left IR signal 1940 and detects the center alignment IR signal 1930, the robot cleaner 100 may define the second expected direction as the forward direction. Therefore, when the UWB measurement result 2010 corresponds to 2014 and the robot cleaner 100 does not detect both the right IR signal 1920 and the left IR signal 1940 and detects the center alignment IR signal 1930, the UWB measurement result 2010 determines that the first expected direction and the second expected direction coincide. In this case, the robot cleaner 100 determines that the robot cleaner 100 is in front when viewed from the charger 110, and moves forward.

When the UWB measurement result 2010 corresponds to 2016, the robot cleaner 100 defines the first expected direction as the left direction. In addition, when the IR signal measurement result 2020 indicates that the right IR signal 1920 is not detected and the left IR signal 1940 is detected, the robot cleaner 100 determines the second expected direction based on the IR signal measurement result 2020 as the left direction. In this case, because the first expected direction and the second expected direction coincide, the robot cleaner 100 determines that the robot cleaner 100 is on the left side when viewed from the charger 110. Accordingly, the robot cleaner 100 moves to the left. In addition, when the UWB measurement result 2010 corresponds to 2012 and the robot cleaner 100 does not detect both the right IR signal 1920 and the left IR signal 1940, the robot cleaner 100 determines the movement direction of the robot cleaner 100 according to the first expected direction. Accordingly, the robot cleaner 100 determines that the robot cleaner 100 is on the left side when viewed from the charger 110, and moves to the left.

When the first expected direction and the second expected direction do not coincide, in operation S1812, the robot cleaner 100 determines the movement direction based on the reliability of the UWB signal.

When the UWB measurement result 2010 corresponds to 2012, the robot cleaner 100 defines the first expected direction as the right direction. In addition, when the IR signal measurement result 2020 indicates that the right IR signal 1920 is not detected and the left IR signal 1940 is detected, the robot cleaner 100 determines the second expected direction based on the IR signal measurement result 2020 as the left direction. When the first expected direction and the second expected direction are different from each other as described above, the UWB measurement result 2010 and the IR signal measurement result 2020 contradict each other. Accordingly, the robot cleaner 100 suspends the determination of the movement direction.

When the UWB measurement result 2010 corresponds to 2014, the robot cleaner 100 defines the first expected direction as the forward direction. In addition, when the IR signal measurement result 2020 indicates that the robot cleaner 100 does not detect the right IR signal 1920 and detects the left IR signal 1940, the robot cleaner 100 defines the second expected direction as the left direction. Conversely, when the IR signal measurement result 2020 indicates that the robot cleaner 100 detects the right IR signal 1920 and does not detect the left IR signal 1940, the robot cleaner 100 defines the second expected direction as the right direction. When the first expected direction and the second expected direction are different from each other as described above, the UWB measurement result 2010 and the IR signal measurement result 2020 contradict each other. Accordingly, the robot cleaner 100 suspends the determination of the movement direction.

When the UWB measurement result 2010 corresponds to 2016, the robot cleaner 100 defines the first expected direction as the left direction. In addition, when the IR signal measurement result 2020 indicates that the right IR signal 1920 is detected and the left IR signal 1940 is not detected, the robot cleaner 100 determines the second expected direction based on the IR signal measurement result 2020 as the right direction. When the first expected direction and the second expected direction are different from each other as described above, the UWB measurement result 2010 and the IR signal measurement result 2020 contradict each other. Accordingly, the robot cleaner 100 suspends the determination of the movement direction.

As such, when the determination of the movement direction is suspended, the robot cleaner 100 determines the movement direction based on the reliability of the UWB signal. Similar to the operations described above with reference to FIG. 17, even in the docking operation, the robot cleaner 100 may determine the movement direction based on an IR signal when the reliability of a UWB signal is less than a reference value, and determine the movement direction based on an IR signal when the reliability of the UWB signal is greater than or equal to the reference value.

When the robot cleaner 100 suspends the determination of the movement direction, the robot cleaner 100 determines the reliability of the UWB signal received from the charger 110. As described above, the reliability may be determined based on an AoA azimuth FOM value and an AoA elevation FOM value that are calculated according to AoA measurement.

When the reliability of the UWB signal is less than the reference value, the robot cleaner 100 may determine the movement direction of the robot cleaner 100 based on the second expected direction determined according to the IR signal measurement result 2020. That is, when the reliability of the UWB signal is less than the reference value, the robot cleaner 100 moves to the right when the right IR signal 1920 is detected, and moves to the left when the left IR signal 1940 is detected. In addition, when both the right IR signal 1920 and the left IR signal 1940 are not detected, the robot cleaner 100 moves in the forward direction.

When the reliability of the UWB signal is greater than or equal to the reference value, the robot cleaner 100 may determine the movement direction of the robot cleaner 100 based on the first expected direction determined based on the UWB measurement result 2010.

Referring to FIG. 21, the charger 110 outputs a collision prevention IR signal 2110. The collision prevention IR signal 2110 has a shorter signal propagation range than those of the wide IR signal 1910, the right IR signal 1920, the left IR signal 1940, and the center alignment IR signal 1930. When the robot cleaner 100 detects the collision prevention IR signal 2110, the robot cleaner 100 reduces its movement speed. In addition, when the robot cleaner 100 detects the collision prevention IR signal 2110, the robot cleaner 100 reduces the interval of detection of a UWB signal and the interval of detection of an IR signal.

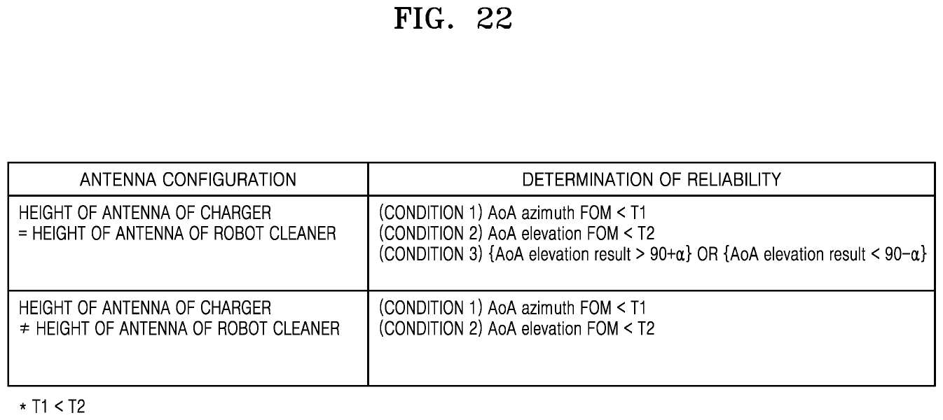

FIG. 22 is a diagram showing criteria for determining the reliability of a UWB signal, according to an embodiment of the present disclosure.

According to an embodiment of the present disclosure, the robot cleaner 100 may determine the reliability of a UWB signal based on a result of AoA measurement of the UWB signal. As described above with reference to FIG. 15, when the robot cleaner 100 performs the homing operation and a result of determining whether an IR signal of the charger is detected (1410) and a UWB signal measurement determination result contradict with each other, which corresponds to suspending of determination, the robot cleaner 100 may operate based on the reliability of the UWB signal. In addition, as described above with reference to FIG. 18, when performing the docking operation, the robot cleaner 100 may operate based on the reliability of the UWB signal. In operation S1812, when the robot cleaner 100 performs the docking operation and a UWB measurement result and an IR signal measurement result contradict each other, the robot cleaner 100 may determine the movement direction based on the reliability of the UWB signal.

The reliability of the UWB signal may be determined based on the antenna configuration of the charger 110 and the robot cleaner 100. Conditions for determining the reliability shown in FIG. 22 may be applied to both a case in which the charger 110 includes two UWB antennas, and a case in which the charger 110 includes three UWB antennas.

According to an embodiment of the present disclosure, in a case in which the height of the antenna of the charger 110 and the height of the antenna of the robot cleaner 100 are equal to each other, the reliability of the UWB signal may be determined by using three conditions. The three conditions include condition 1, condition 2, and condition 3. Condition 1 is that an AoA azimuth FOM value are less than a value T1. Condition 2 is that an AoA elevation FOM value is less than a value T2. Condition 3 is that an AoA elevation result value is greater than (90+α) or less than (90−α). Here, T1 and T2 are predetermined reference values. α may correspond to an elevation angle reference value. According to an embodiment, T2 is greater than T1. When the result of AoA measurement of the UWB signal satisfies all of condition 1, condition 2, and condition 3, the robot cleaner 100 determines that the reliability is greater than or equal to the reference value. When the result of AoA measurement of the UWB signal does not satisfy at least one of condition 1, condition 2, or condition 3, the robot cleaner 100 determines that the reliability is less than the reference value.

According to an embodiment of the present disclosure, in a case in which the height of the antenna of the charger 110 and the height of the antenna of the robot cleaner 100 are different from each other, the reliability of the UWB signal may be determined by using two conditions. The two conditions include condition 1 and condition 2. Condition 1 is that an AoA azimuth FOM value are less than a value T1. Condition 2 is that an AoA elevation FOM value is less than a value T2. Here, T1 and T2 are predetermined reference values. In a case in which the height of the antenna of the charger 110 and the height of the antenna of the robot cleaner 100 are different from each other, the condition for an AoA elevation result cannot be used. According to an embodiment, T2 is greater than T1. When the result of AoA measurement of the UWB signal satisfies both condition 1 and condition 2, the robot cleaner 100 determines that the reliability is greater than or equal to the reference value. When the result of AoA measurement of the UWB signal does not satisfy at least one of condition 1 or condition 2, the robot cleaner 100 determines that the reliability is less than the reference value.

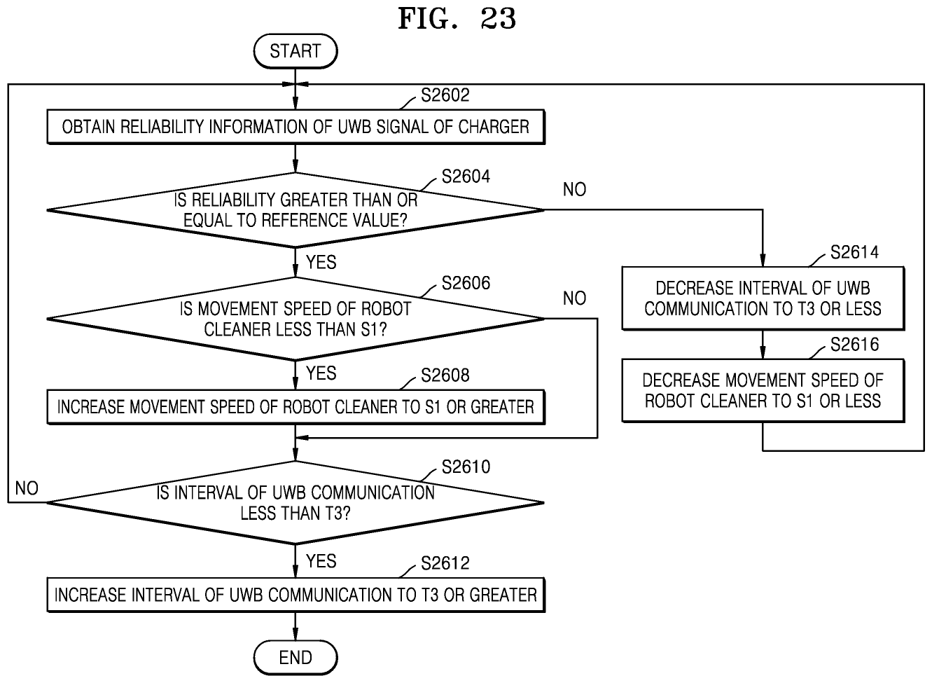

FIG. 23 is a flowchart of a process of controlling a robot cleaner based on the reliability of a UWB signal, according to an embodiment of the present disclosure.

According to an embodiment of the present disclosure, the robot cleaner 100 may adjust an interval of UWB communication and the movement speed of the robot cleaner 100, based on the reliability of a UWB signal output from the charger 110.

First, in operation S2602, the robot cleaner 100 obtains reliability information of the UWB signal output from the charger 110. The reliability information of the UWB signal may correspond to a FOM value of AoA measurement, as described above with reference to FIG. 7. The reliability information may include an AoA azimuth FOM value and an AoA elevation FOM value.

Next, in operation S2604, the robot cleaner 100 determines whether the reliability of the UWB signal is greater than or equal to a reference value. Whether the reliability of the UWB signal is greater than or equal to the reference value may be determined as described above with reference to FIG. 22.

When the reliability of the UWB signal is greater than or equal to the reference value, in operation S2606, the robot cleaner 100 determines whether the movement speed of the robot cleaner 100 is less than a reference value S1. When the movement speed of the robot cleaner 100 is less than the reference value S1, in operation S2608, the robot cleaner 100 increases the movement speed of the robot cleaner 100 to S1 or greater. The processor 210 of the robot cleaner 100 may adjust the movement speed of the robot cleaner 100 by controlling the moving assembly 214. In addition, when the reliability of the UWB signal is greater than or equal to the reference value, in operation S2610, the robot cleaner 100 determines whether the interval of UWB communication is less than T3. When the interval of UWB communication of the robot cleaner 100 is less than T3, in operation S2612, the robot cleaner 100 increases the interval of UWB communication to T3 or greater. The order of operations S2606 and S2610 is not limited to the example shown in FIG. 23. It is also possible to perform operation S2610 first and then perform operation S2606. In addition, it is also possible to perform operations S2606 and S2608 of controlling the speed of the robot cleaner 100, and operations S2610 and S2612 of controlling the interval of UWB communication of the robot cleaner 100 in parallel.

When the reliability of the UWB signal is less than the reference value, in operation S2614, the robot cleaner 100 decreases the interval of UWB communication to T3 or less. In addition, when the reliability of the UWB signal is less than the reference value, in operation S2616, the robot cleaner 100 decreases the movement speed to S1 or less. The order of operations S2614 and S2616 is not limited to the example shown in FIG. 23. It is also possible to perform operation S2616 first and then perform operation S2614. In addition, it is also possible to perform operations S2614 and S2616 of the robot cleaner 100 in parallel.

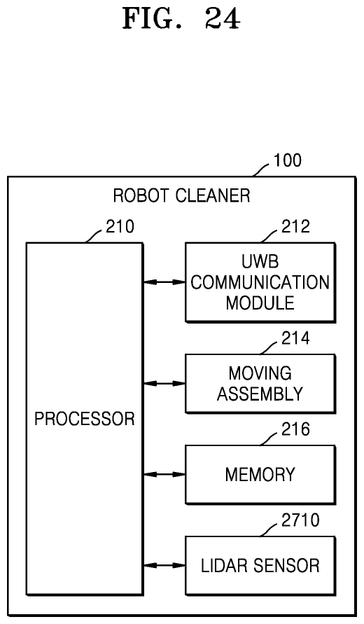

FIG. 24 is a block diagram illustrating a structure of a robot cleaner according to an embodiment of the present disclosure.

According to an embodiment of the present disclosure, the robot cleaner 100 includes the processor 210, the UWB communication module 212, the moving assembly 214, the memory 216, and a LiDAR sensor 2710. In an embodiment, the robot cleaner 100 may include the processor 210, the UWB communication module 212, the moving assembly 214, the memory 216, the IR communication module 1010, and the LiDAR sensor 2710. The processor 210, the UWB communication module 212, the moving assembly 214, and the memory 216 of FIG. 24 are similar to those described above with reference to FIG. 2. Thus, the configuration of the robot cleaner 100 will be described with reference to FIG. 24, focusing on the difference from the embodiment of FIG. 2, and the LiDAR sensor 2710.

The LiDAR sensor 2710 is a sensor using a LiDAR sensing method. The LiDAR sensor 2710 outputs a laser and detects the laser reflected from an obstacle in front. The LiDAR sensor 2710 outputs light in a particular pattern and extracts information based on the light reflected from an obstacle. The LiDAR sensor 2710 may extract parameter values such as pulse power, a round-trip time, a phase shift, or a pulse width.

The processor 210 detects an obstacle in front by using a detection value of the lidar sensor 2710. The processor 210 may detect a wall, furniture, a doorway, an obstacle on a floor, and the like by using a detection value of the LiDAR sensor 2710. In addition, the processor 210 may identify the type of an obstacle and determine a movement path according to the type of the obstacle, by using a detection value of the LiDAR sensor 2710.

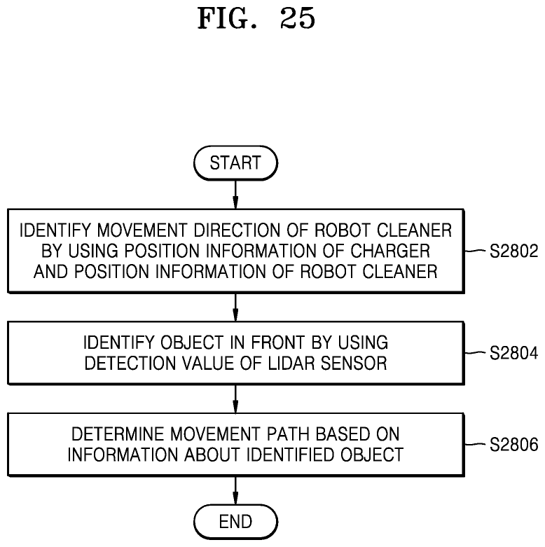

FIG. 25 is a flowchart of a process, performed by a robot cleaner, of determining a movement path, according to an embodiment of the present disclosure.

The process shown in FIG. 25 may correspond to operation S408 of FIG. 4.

In operation S2802, the robot cleaner 100 identifies the movement direction of the robot cleaner 100 by using position information of the charger 110 and position information of the robot cleaner 100. The robot cleaner 100 may set a movement direction to move toward the charger 110.

Next, in operation S2804, the robot cleaner 100 identifies an object in front by using a detection value of the LiDAR sensor 2710. The robot cleaner 100 may detect a wall, furniture, a doorway, an obstacle on a floor, and the like by using the detection value of the LiDAR sensor 2710. The robot cleaner 100 moves to avoid a wall, furniture, an obstacle, and the like. The robot cleaner 100 recognizes a wall and furniture to recognize the structure of a cleaning area. Information about the wall and the furniture may be stored in map information. The robot cleaner 100 may generate and store map information by using the detection value of the LiDAR sensor 2710. After the map information is generated, the robot cleaner 100 may set a movement path by using the stored map information. In addition, the robot cleaner 100 recognizes an obstacle in front by using the detection value of the LiDAR sensor 2710.

Next, in operation S2806, the robot cleaner 100 determines a movement path based on information about the identified object. The robot cleaner 100 sets the movement path to clean an empty space of a cleaning space, based on the information about the identified object. In addition, the robot cleaner 100 sets the movement path to avoid colliding with a wall and furniture. In addition, the robot cleaner 100 sets the movement path to avoid an obstacle.

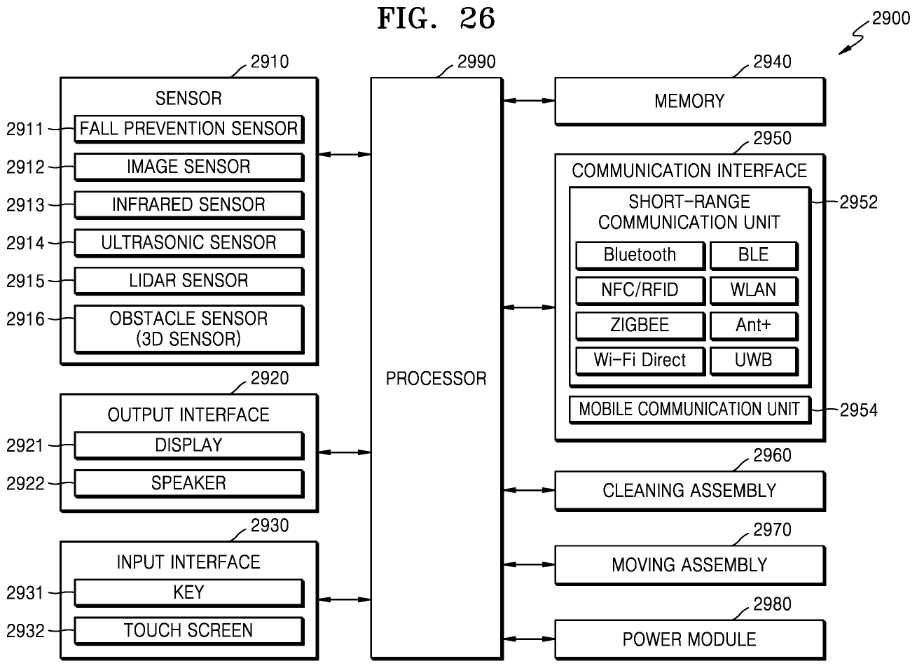

FIG. 26 is a diagram illustrating a structure of a robot cleaner according to an embodiment of the present disclosure.

A robot cleaner 2900 according to an embodiment of the present disclosure includes a sensor 2910, an output interface 2920, an input interface 2930, a memory 2940, a communication interface 2950, a cleaning assembly 2960, a moving assembly 2970, a power module 2980, and a processor 2990. The robot cleaner 2900 may be configured by various combinations of the components illustrated in FIG. 26, and the components illustrated in FIG. 26 are not essential components.

The robot cleaner 2900 of FIG. 26 corresponds to the robot cleaner 100 described above with reference to FIGS. 2, 10, and 24. A LiDAR sensor 2915 corresponds to the LiDAR sensor 2710 described above with reference to FIG. 24. The memory 2940 corresponds to the memory 216 described above with reference to FIG. 2. The communication interface 2950 corresponds to the UWB communication module 212 described above with reference to FIG. 2 and the IR communication module 1010 described above with reference to FIG. 10. The processor 2990 corresponds to the processor 210 described above with reference to FIG. 2. The moving assembly 2970 corresponds to the moving assembly 214 described above with reference to FIG. 2.

The sensor 2910 may include various types of sensors, for example, at least one of a fall prevention sensor 2911, an image sensor 2912, an IR sensor 2913, an ultrasonic sensor 2914, the LiDAR sensor 2915, an obstacle sensor 2916, or a mileage sensor (not shown), or a combination thereof. The mileage sensor may include a rotation sensor configured to calculate the number of rotations of a wheel. For example, the rotation sensor may be an encoder installed to detect the number of rotations of a motor. A plurality of image sensors 2912 may be arranged in the robot cleaner 2900 according to an implementation. Functions of the sensors may be intuitively inferred by those of skill in the art from their names, and thus, detailed descriptions thereof will be omitted.

The output interface 2920 may include at least one of a display 2921 or a speaker 2922, or a combination thereof. The output interface 2920 outputs various notifications, messages, information, and the like generated by the processor 2990.

The input interface 2930 may include a key 2931, a touch screen 2932, a touch pad, and the like. The input interface 2930 receives a user input and delivers the user input to the processor 2990.

The memory 2940 stores various pieces of information, data, instructions, programs, and the like necessary for an operation of the robot cleaner 2900. The memory 2940 may include at least one of volatile memory or non-volatile memory, or a combination thereof. The memory 2940 may include at least one of a flash memory-type storage medium, a hard disk-type storage medium, a multimedia card micro-type storage medium, a card-type memory (e.g., SD or XD memory), RAM, SRAM, ROM, EEPROM, PROM, magnetic memory, a magnetic disk, or an optical disc. In addition, the robot cleaner 2900 may operate a web storage or a cloud server that performs a storage function on the Internet.

The communication interface 2950 may include at least one of a short-range communication unit 2952 or a mobile communication unit 2954, or a combination thereof. The communication interface 2950 may include at least one antenna for wireless communication with other devices.

The short-range communication unit 2952 may include, but is not limited to, a Bluetooth communication unit, a Bluetooth Low Energy (BLE) communication unit, an NFC unit, a wireless local area network (WLAN) (e.g., Wi-Fi) communication unit, a Zigbee communication unit, an IrDA communication unit, a Wi-Fi Direct (WFD) communication unit, a UWB communication unit, an Ant+ communication unit, a microwave (uWave) communication unit, and the like.

The mobile communication unit 2954 transmits and receives radio signals to and from at least one of a base station, an external terminal, or a server, on a mobile communication network. Here, the radio signals may include a voice call signal, a video call signal, or various types of data according to text/multimedia message transmission and reception.

The cleaning assembly 2960 may include a main brush assembly installed in a lower portion of a main body to sweep or scatter dust on a floor and suck in the swept or scattered dust, and a side brush assembly installed in a lower portion of the main body and protruding toward the outside to sweep dust on areas other than an area being cleaned by the main brush assembly and to deliver the swept dust to the main brush assembly. In addition, the cleaning assembly 2960 may include a vacuum cleaning module for performing vacuum suction or a wet-mop cleaning module for performing wet-mop cleaning.

The moving assembly 2970 moves the main body of the robot cleaner 2900. The moving assembly may include a pair of wheels that allow the robot cleaner 2900 to move forward and backward, and rotate, a wheel motor that applies a moving force to each wheel, a caster wheel that is installed in a front portion of the main body to rotate according to the state of a floor surface on which the robot cleaner 2900 moves, and thus change its angle, and the like. The moving assembly 2970 moves the robot cleaner 2900 under control of the processor 2990. The processor 2990 determines a travel path and controls the moving assembly 2970 to move the robot cleaner 2900 along the determined travel path.

The power module 2980 supplies power to the robot cleaner 2900. The power module 2980 includes a battery, a power driving circuit, a converter, a transformer circuit, and the like. The power module 2980 connects to a charging station to charge the battery and supplies power charged in the battery to the components of the robot cleaner 2900.

The processor 2990 controls the overall operation of the robot cleaner 2900. The processor 2990 may execute a program stored in the memory 2940 to control the components of the robot cleaner 2900.

According to an embodiment of the present disclosure, the processor 2990 may include a separate neural processing unit (NPU) configured to perform an operation of a machine learning model. In addition, the processor 2990 may include a central processing unit (CPU), a graphics processing unit (GPU), and the like.

The processor 2990 may perform operations of the robot cleaner 2900, such as controlling an operation mode, determining and controlling a travel path, recognizing an obstacle, controlling a cleaning operation, recognizing a position, communicating with an external server, monitoring a remaining charge of the battery, or controlling a battery charging operation.

A machine-readable storage medium may be provided in the form of a non-transitory storage medium. Here, the term ‘non-transitory storage medium’ refers to a tangible device and does not include a signal (e.g., an electromagnetic wave), and the term ‘non-transitory storage medium’ does not distinguish between a case where data is stored in a storage medium semi-permanently and a case where data is stored temporarily. For example, the ‘non-transitory storage medium’ may include a buffer in which data is temporarily stored.

According to an embodiment of the present disclosure, methods according to various embodiments disclosed herein may be included in a computer program product and then provided. The computer program product may be traded as commodities between sellers and buyers. The computer program product may be distributed in the form of a machine-readable storage medium (e.g., a compact disc ROM (CD-ROM)), or may be distributed online (e.g., downloaded or uploaded) through an application store or directly between two user devices (e.g., smart phones). In a case of online distribution, at least a portion of the computer program product (e.g., a downloadable app) may be temporarily stored in a machine-readable storage medium such as a manufacturer's server, an application store's server, or a memory of a relay server.

According to an aspect of an embodiment of the present disclosure, a method of controlling a robot cleaner is provided. The method of controlling the robot cleaner includes initiating a homing operation of moving the robot cleaner to a charger. In addition, the method of controlling the robot cleaner further includes, by a UWB antenna of the robot cleaner, detecting a plurality of UWB signals output from a plurality of UWB antennas included in the charger. In addition, the method of controlling the robot cleaner further includes identifying position information of the charger and position information of the robot cleaner based on the plurality of UWB signals. In addition, the method of controlling the robot cleaner further includes controlling the robot cleaner to move to the charger based on the identified position information of the charger and the identified position information of the robot cleaner. In addition, according to an embodiment of the present disclosure, the charger may include three UWB antennas arranged at the same height, and the identifying of the position information may include identifying coordinates of the charger and coordinates of the robot cleaner in a coordinate system having an origin at any one of the three UWB antennas included in the charger.

In addition, according to an embodiment of the present disclosure, the controlling of the robot cleaner to move to the charger may include: identifying a movement direction of the robot cleaner to move to the charger, by using the position information of the charger and the position information of the robot cleaner; identifying an object in front by using a detection value of a LiDAR sensor of the robot cleaner; and determining a movement path of the robot cleaner based on information about the identified object in front.

In addition, according to an embodiment of the present disclosure, the method of controlling the robot cleaner may further include: obtaining reliability information of the plurality of UWB signals; and controlling a movement speed of the robot cleaner based on the reliability information of the plurality of UWB signals.

In addition, according to an embodiment of the present disclosure, the controlling of the movement speed may include: based on the reliability of the plurality of UWB signals being less than a reference value, controlling the movement speed of the robot cleaner to be less than a reference speed; and based on the reliability of the plurality of UWB signals being greater than or equal to the reference value, controlling the movement speed of the robot cleaner to be greater than or equal to the reference speed.

In addition, according to an embodiment of the present disclosure, a method of controlling the robot cleaner may further include: based on the reliability of the plurality of UWB signals being less than a reference value, controlling an interval of detection of the plurality of UWB signals to be less than or equal to a reference interval; and based on the reliability of the plurality of UWB signals being greater than or equal to the reference value, controlling the interval of detection of the plurality of UWB signals to be greater than or equal to the reference interval.

In addition, according to an embodiment of the present disclosure, the plurality of UWB antennas of the charger may be arranged at the same height, the method of controlling the robot cleaner may further include: obtaining an AoA azimuth and an AoA elevation angle of the plurality of UWB signals; and obtaining an AoA azimuth FOM and an AoA elevation angle FOM of the plurality of UWB signals, and the obtaining of the reliability information may include obtaining the reliability information based on at least one of the AoA azimuth FOM or the AoA elevation angle FOM.

In addition, according to an embodiment of the present disclosure, the plurality of UWB antennas of the charger and the UWB antenna of the robot cleaner may be arranged at the same height, and the obtaining of the reliability information may further include obtaining the reliability information based on whether the AoA elevation angle deviates from 90 degrees by greater than an elevation angle reference value.

In addition, according to an embodiment of the present disclosure, the charger may include two UWB antennas and an IR communication module, and the identifying of the position information may include: determining a first candidate position and a second candidate position of the robot cleaner based on a plurality of UWB signals output from the two UWB antennas; and identifying one of the first candidate position and the second candidate position as a position of the robot cleaner, based on an IR signal output from an IR signal module.

In addition, according to an embodiment of the present disclosure, the charger may further include an IR communication module, and the method of controlling the robot cleaner may further include: detecting an IR signal output from the IR communication module; initiating a docking operation of docking the robot cleaner to the charger based on the IR signal; and docking the robot cleaner to the charger such that a charging port of the charger and a charging port of the robot cleaner come into contact with each other, based on the IR signal.

In addition, according to an embodiment of the present disclosure, the IR communication module may be configured to output a wide IR signal, a right IR signal, a left IR signal, and a center alignment IR signal, and the initiating of the docking operation may include initiating the docking operation based on detecting the wide IR signal, the docking of the robot cleaner may include docking the robot cleaner based on the right IR signal, the left IR signal, and the center alignment IR signal.

In addition, according to an embodiment of the present disclosure, the plurality of UWB antennas included in the charger may include a second UWB antenna arranged on a right side and a third UWB antenna arranged on a left side, and the method may further include: determining a first expected direction of the robot cleaner based on a second UWB signal output from the second UWB antenna and a third UWB signal output from the third UWB antenna; determining a second expected direction of the robot cleaner based on a combination of the right IR signal and the left IR signal; and based on determining that the first expected direction and the second expected direction coincide, determining a movement direction of the robot cleaner based on the first expected direction and the second expected direction.

In addition, according to an embodiment of the present disclosure, the method of controlling the robot cleaner may further include: based on determining that the first expected direction and the second expected direction are different from each other, determining reliability of the second UWB signal and reliability of the third UWB signal; based on the reliability of the second UWB signal or the reliability of the third UWB signal being less than a reference value, determining the movement direction of the robot cleaner based on the second expected direction; and based on the reliability of the second UWB signal being greater than or equal to the reference value and the reliability of the third UWB signal being greater than or equal to the reference value, determining the movement direction of the robot cleaner based on the first expected direction.

In addition, according to an embodiment of the present disclosure, the method of controlling the robot cleaner may further include: based on determining that the first expected direction and the second expected direction are different from each other, determining whether a reference UWB device is present; based on the reference UWB device being present, requesting measurement of a UWB signal from the reference UWB device; receiving a result of measurement of the UWB signal, from the reference UWB device; based on reliability of the UWB signal in the result of measurement of the UWB signal received from the reference UWB device being less than a reference value, determining a moving direction of the robot cleaner based on the second expected direction; and based on the reliability of the UWB signal in the result of measurement of the UWB signal received from the reference UWB device being greater than or equal to the reference value, determining the moving direction of the robot cleaner based on the first expected direction.

In addition, according to an aspect of an embodiment of the present disclosure, a robot cleaner is provided. The robot cleaner includes a UWB antenna. In addition, the robot cleaner further includes a UWB communication module configured to detect a UWB signal. In addition, the robot cleaner further includes a moving assembly. In addition, the robot cleaner further includes a memory storing at least one instruction. In addition, the robot cleaner further includes at least one processor. The at least one processor executes the at least one instruction to initiate a homing operation of moving the robot cleaner to the charger. In addition, the at least one processor executes the at least one instruction to detect, by the UWB antenna of the robot cleaner, a plurality of UWB signals output from a plurality of UWB antennas included in the charger. In addition, the at least one processor executes the at least one instruction to identify position information of the charger and position information of the robot cleaner based on the plurality of UWB signals. In addition, the at least one processor executes the at least one instruction to control the moving assembly such that the robot cleaner moves to the charger, based on the identified position information of the charger and the identified position information of the robot cleaner.

In addition, according to an aspect of an embodiment of the present disclosure, provided is a computer-readable recording medium having recorded thereon a program for executing, on a computer, the method of controlling the robot cleaner.

1. A method of controlling a robot cleaner, the method comprising:
initiating a homing operation of moving the robot cleaner to a charger;
detecting, by an ultra-wideband antenna of the robot cleaner, a plurality of UWB signals output from a plurality of UWB antennas included in the charger;
identifying position information of the charger and position information of the robot cleaner based on the detected plurality of UWB signals; and
controlling the robot cleaner to move to the charger based on the identified position information of the charger and the identified position information of the robot cleaner.

2. The method of claim 1, wherein
the charger includes three UWB antennas arranged at a same height, and
the identifying of the position information includes identifying coordinates of the charger and coordinates of the robot cleaner in a coordinate system having an origin at any one of the three UWB antennas included in the charger.

3. The method of claim 1, wherein the controlling of the robot cleaner to move to the charger includes:
identifying a movement direction of the robot cleaner to move to the charger, by using the identified position information of the charger and the identified position information of the robot cleaner,
identifying an object in front of the robot cleaner by using a detection value of a light detection and ranging (LiDAR) sensor of the robot cleaner, and
determining a movement path of the robot cleaner based on information about the identified object in front of the robot cleaner.

4. The method of claim 1, further comprising:
obtaining reliability information of the detected plurality of UWB signals; and
controlling a movement speed of the robot cleaner based on the obtained reliability information.

5. The method of claim 4, wherein the controlling of the movement speed includes:
based on reliability of the detected plurality of UWB signals indicated by the obtained reliability information being less than a reference value, controlling the movement speed of the robot cleaner to be less than a reference speed, and
based on the reliability of the detected plurality of UWB signals indicated by the obtained reliability information being greater than or equal to the reference value, controlling the movement speed of the robot cleaner to be greater than or equal to the reference speed.

6. The method of claim 4, further comprising:
based on reliability of the detected plurality of UWB signals indicated by the obtained reliability information being less than a reference value, controlling an interval of detection of the plurality of UWB signals to be less than or equal to a reference interval; and
based on the reliability of the detected plurality of UWB signals indicated by the obtained reliability information being greater than or equal to the reference value, controlling the interval of detection of the plurality of UWB signals to be greater than or equal to the reference interval.

7. The method of claim 4, wherein
the plurality of UWB antennas of the charger are arranged at a same height, and
the method further comprises:
obtaining an angle-of-arrival (AoA) azimuth and an AoA elevation angle of the plurality of UWB signals; and
obtaining an AoA azimuth figure of merit (FOM) and an AoA elevation angle FOM of the plurality of UWB signals, and
the obtaining of the reliability information includes obtaining the reliability information based on at least one of the obtained AoA azimuth FOM or the obtained AoA elevation angle FOM.

8. The method of claim 7, wherein
the plurality of UWB antennas of the charger and the UWB antenna of the robot cleaner are arranged at a same height, and
the obtaining of the reliability information further includes obtaining the reliability information based on whether the AoA elevation angle deviates from 90 degrees by greater than an elevation angle reference value.

9. The method of claim 1, wherein
the charger includes two UWB antennas and an IR communication module, and
the identifying of the position information includes:
determining a first candidate position and a second candidate position of the robot cleaner based on a plurality of UWB signals output from the two UWB antennas, and
identifying one of the first candidate position and the second candidate position as a position of the robot cleaner, based on an infrared (IR) signal output from an IR signal module.

10. The method of claim 1, wherein
the charger further includes an IR communication module, and
the method further comprises:
detecting an IR signal output from the IR communication module;
initiating a docking operation of docking the robot cleaner to the charger based on the detected IR signal; and
docking the robot cleaner to the charger such that a charging port of the charger and a charging port of the robot cleaner come into contact with each other, based on the detected IR signal.

11. The method of claim 10, wherein
the IR communication module is configured to output a wide IR signal, a right IR signal, a left IR signal, and a center alignment IR signal,
the initiating of the docking operation includes initiating the docking operation based on detecting the wide IR signal, and
the docking of the robot cleaner includes docking the robot cleaner based on the right IR signal, the left IR signal, and the center alignment IR signal.

12. The method of claim 11, wherein
the plurality of UWB antennas included in the charger include a second UWB antenna arranged on a right side of the charger and a third UWB antenna arranged on a left side of the charger, and
the method further comprises:
determining a first expected direction of the robot cleaner based on a second UWB signal output from the second UWB antenna and a third UWB signal output from the third UWB antenna;
determining a second expected direction of the robot cleaner based on a combination of the right IR signal and the left IR signal; and
based on determining that the first expected direction and the second expected direction coincide, determining a movement direction of the robot cleaner based on the determined first expected direction and the determined second expected direction.

13. The method of claim 12, further comprising:
based on determining that the determined first expected direction and the determined second expected direction are different from each other, determining reliability of the second UWB signal and reliability of the third UWB signal;
based on the determined reliability of the second UWB signal or the determined reliability of the third UWB signal being less than a reference value, determining the movement direction of the robot cleaner based on the determined second expected direction; and
based on the determined reliability of the second UWB signal being greater than or equal to the reference value and the determined reliability of the third UWB signal being greater than or equal to the reference value, determining the movement direction of the robot cleaner based on the determined first expected direction.

14. A robot cleaner comprising:
an ultra-wideband (UWB) communication module including a UWB antenna and configured to detect a UWB signal;
a moving assembly;
a memory storing at least one instruction; and
at least one processor configured to execute the at least one instruction to:
initiate a homing operation of moving the robot cleaner to a charger (110),
detect, by the UWB antenna, a plurality of UWB signals output from a plurality of UWB antennas included in the charger,
identify position information of the charger and position information of the robot cleaner based on the detected plurality of UWB signals, and
control the moving assembly such that the robot cleaner moves to the charger, based on the identified position information of the charger and the identified position information of the robot cleaner.

15. A non-transitory computer-readable recording medium having recorded thereon a program for executing, on a computer, the method of claim 1.
